(19) United States
(12) Patent Application Publication
(10) Pub. No.: US 2014/0038589 A1
(43) Pub. Date: Feb. 6, 2014

(54) SYSTEM TO SERVE AS AN INDEPENDENT MULTIMEDIA EXCHANGE WITH ONE OR MORE SELF CORRECTING AND COLLABORATIVE PROPERTIES

(71) Applicant: Subramanian Sahasranamam, Chennai (IN)

(72) Inventor: Subramanian Sahasranamam, Chennai (IN)

(21) Appl. No.: 13/567,980

(22) Filed: Aug. 6, 2012

(51) Int. Cl. H04W 40/00

(52) U.S. Cl. 455/422.1

(57) ABSTRACT

The present invention is a system to serve as an independent multimedia exchange with one or more self-correcting and collaborative properties that includes one or more intelligent call processing agents that are a software portion of a mobile device, one or more intelligent call processing engines that are a server system located in a computer cloud that configure one or more intelligent call processing agents and one or more filter and routing scripts that are a plurality of XML based instructions created and provided by the one or more intelligent call processing engines and are executed and transmitted to the one or more intelligent call processing agents. The system also includes one or more alternative call processing scripts produced by a graphical user interface based call processing editing program and is processed by one or more intelligent call processing engines.

### TECHNICAL FIELD & BACKGROUND

Every mobile user should be able to communicate with one or more desired features to one or more other mobile users. A user should not be dependent on the features listed by a multimedia service provider. There should be no scalability limit imposed by a centralized service provider, rather every mobile user with just an Internet connection should be able to serve and communicate to others with one or more desired features and functionalities.

The present invention generally relates to a system. More specifically, the invention is a system to serve as an independent multimedia exchange with one or more self-correcting and collaborative properties.

It is an object of the invention to provide a system to serve as an independent multimedia exchange with one or more self-correcting and collaborative properties that includes a computer cloud.

It is an object of the invention to provide a system to serve as an independent multimedia exchange with one or more self-correcting and collaborative properties that allow every user to have a desired multimedia calling and multimedia communication feature without a centralized service provider.

It is an object of the invention to provide a system to serve as an independent multimedia exchange with one or more self-correcting and collaborative properties where a user can have one or more custom defined communication mechanisms.

What is really needed is a system to serve as an independent multimedia exchange with one or more self-correcting and collaborative properties that includes a computer cloud that allow every user to have a desired multimedia calling and multimedia communication feature without a centralized service provider where a user can have one or more custom defined communication mechanisms.

### BRIEF DESCRIPTION OF THE DRAWINGS

The present invention will be described by way of exemplary embodiments, but not limitations, illustrated in the accompanying drawing in which like references denote similar elements, and in which:

FIG. 1A illustrates a system overview of a system to serve as an independent multimedia exchange with one or more self-correcting and collaborative properties being registered and preloaded, in accordance with one embodiment of the present invention.

FIG. 1B illustrates a system overview of a system to serve as an independent multimedia exchange with one or more self-correcting and collaborative properties being distributed, in accordance with one embodiment of the present invention.

FIG. 2 is a flowchart of a user creating a new user ID in a system 200 to serve as an independent multimedia exchange with one or more self-correcting and collaborative properties being distributed, in accordance with one embodiment of the present invention.

FIG. 3 is a flowchart of a method for a user signing in and logging out of a system to serve as an independent multimedia exchange with one or more self-correcting and collaborative properties being distributed, in accordance with one embodiment of the present invention.

FIG. 4 is a flowchart of a method for a user managing contacts in a system to serve as an independent multimedia exchange with one or more self-correcting and collaborative properties being distributed, in accordance with one embodiment of the present invention.

FIG. 5 is a flowchart of a method for a heartbeat request in a system to serve as an independent multimedia exchange with one or more self-correcting and collaborative properties being distributed, in accordance with one embodiment of the present invention.

FIG. 6 is a flowchart of a method of a user initiating a communication service without a relay server with one or more buddies in a system to serve as an independent multimedia exchange with one or more self-correcting and collaborative properties being distributed, in accordance with one embodiment of the present invention.

FIG. 7 is a flowchart of a method for a user initiating a communication service with a relay server with one or more buddies in a system to serve as an independent multimedia exchange with one or more self-correcting and collaborative properties being distributed, in accordance with one embodiment of the present invention.

FIG. 8 is a flowchart of a method for a user communicating with one or more buddies based on a rule in a system to serve as an independent multimedia exchange with one or more self-correcting and collaborative properties being distributed, in accordance with one embodiment of the present invention.

FIG. 9 is a flowchart of a method for a plurality of message sequence calls in a system to serve as an independent multimedia exchange with one or more self-correcting and collaborative properties being distributed, in accordance with one embodiment of the present invention.

FIG. 10 is a front perspective view of a user interface with a plurality of media settings utilized in a system to serve as an independent multimedia exchange with one or more self-correcting and collaborative properties being distributed, in accordance with one embodiment of the present invention.

FIG. 11 is a flowchart of a method for performing one or more media settings in a system to serve as an independent multimedia exchange with one or more self-correcting and collaborative properties being distributed, in accordance with one embodiment of the present invention.

FIG. 12 is a front perspective view of a user interface with a plurality of parallel media settings utilized in a system to serve as an independent multimedia exchange with one or more self-correcting and collaborative properties being distributed, in accordance with one embodiment of the present invention.

FIG. 13 is a front perspective view of a pair of user interfaces with a plurality of media restriction settings utilized in a system to serve as an independent multimedia exchange with one or more self-correcting and collaborative properties being distributed, in accordance with one embodiment of the present invention.

FIG. 14 is a flowchart of a method for performing recording media and playing the media later in a system to serve as an independent multimedia exchange with one or more self-correcting and collaborative properties being distributed, in accordance with one embodiment of the present invention.

FIG. 15 is a front perspective view of a pair of user interfaces with a plurality of select buddy and call events settings and a plurality of select services settings utilized in a system to serve as an independent multimedia exchange with one or more self-correcting and collaborative properties being distributed, in accordance with one embodiment of the present invention.

FIG. 16 is a front perspective view of a pair of user interfaces with a plurality of selected conditions settings and a plurality of selected actions settings utilized in a system to serve as an independent multimedia exchange with one or more self-correcting and collaborative properties being distributed, in accordance with one embodiment of the present invention.

FIG. 17 is a flowchart of a method for performing a location based rule setting in a system to serve as an independent multimedia exchange with one or more self-correcting and collaborative properties being distributed, in accordance with one embodiment of the present invention.

FIG. 18 is a front perspective view of 4 user interfaces with a plurality of selected conditions settings and a plurality of selected actions settings utilized in a system to serve as an independent multimedia exchange with one or more self-correcting and collaborative properties being distributed, in accordance with one embodiment of the present invention.

FIG. 19 is a flowchart of a method for enforcing one or more rules on a buddy in a system to serve as an independent multimedia exchange with one or more self-correcting and collaborative properties being distributed, in accordance with one embodiment of the present invention.

FIG. 20 is a front perspective view of a pair of user interfaces with a plurality of selected conditions settings and a plurality of selected actions settings for enforcing one or more rules on a buddy utilized in a system to serve as an independent multimedia exchange with one or more self-correcting and collaborative properties being distributed, in accordance with one embodiment of the present invention.

FIG. 21 is a flowchart of a method for establishing one or more dynamic media rules in a hosted conference in a system to serve as an independent multimedia exchange with one or more self-correcting and collaborative properties being distributed, in accordance with one embodiment of the present invention.

FIG. 22 is a front perspective view of a user interface for establishing one or more dynamic media rules in a hosted conference, in accordance with one embodiment of the present invention.

FIG. 23 is a flowchart of a method for establishing one or more dynamic media rules in a hosted conference in a system to serve as an independent multimedia exchange with one or more self-correcting and collaborative properties being distributed, in accordance with one embodiment of the present invention.

FIG. 24 is a front perspective view of a user interface for establishing one or more dynamic media rules in a hosted conference, in accordance with one embodiment of the present invention.

FIG. 25 is a flowchart of a method for streaming media based on an event in a system to serve as an independent multimedia exchange with one or more self-correcting and collaborative properties being distributed, in accordance with one embodiment of the present invention.

FIG. 26 is a front perspective view of a pair of user interfaces with a plurality of selected conditions settings and a plurality of selected actions settings in a system to serve as an independent multimedia exchange with one or more self-correcting and collaborative properties being distributed, in accordance with one embodiment of the present invention.

FIG. 27 is a flowchart of a method for one or more buddies to access a plurality of user files in a system to serve as an independent multimedia exchange with one or more self-correcting and collaborative properties being distributed, in accordance with one embodiment of the present invention.

FIG. 28 is a front perspective view of a user interface for selecting a media that a user would like to view in a system to serve as an independent multimedia exchange with one or more self-correcting and collaborative properties being distributed, in accordance with one embodiment of the present invention.

FIG. 29 is a flowchart of a method for one or more buddies to access a plurality of user files in a system to serve as an independent multimedia exchange with one or more self-correcting and collaborative properties being distributed, in accordance with one embodiment of the present invention.

FIG. 30 is a front perspective view of 4 user interfaces for one or more buddies to access a plurality of user files in a system to serve as an independent multimedia exchange with one or more self-correcting and collaborative properties being distributed, in accordance with one embodiment of the present invention.

FIG. 31 is a flowchart of a method for call forwarding an event to a system to serve as an independent multimedia exchange with one or more self-correcting and collaborative properties being distributed, in accordance with one embodiment of the present invention.

FIG. 32 is a front perspective view of a pair of user interfaces to call forward an event in a system to serve as an independent multimedia exchange with one or more self-correcting and collaborative properties being distributed, in accordance with one embodiment of the present invention.

FIG. 33 is a flowchart of a method for converting a chat to another relevant service for a system to serve as an independent multimedia exchange with one or more self-correcting and collaborative properties being distributed, in accordance with one embodiment of the present invention.

FIG. 34 is a front perspective view of 4 user interfaces to convert a chat to another relevant service in a system to serve as an independent multimedia exchange with one or more self-correcting and collaborative properties being distributed, in accordance with one embodiment of the present invention.

FIG. 35 is a flowchart of a method for generating a blacklist and a forward list for a system to serve as an independent multimedia exchange with one or more self-correcting and collaborative properties being distributed, in accordance with one embodiment of the present invention.

FIG. 36 is a front perspective view of a user interface for generating a blacklist and a forward list in a system to serve as an independent multimedia exchange with one or more self-correcting and collaborative properties being distributed, in accordance with one embodiment of the present invention.

FIG. 37 is a flowchart of a method for call hunting a system to serve as an independent multimedia exchange with one or more self-correcting and collaborative properties being distributed, in accordance with one embodiment of the present invention.

FIG. 38 is a front perspective view of a user interface for call hunting in a system to serve as an independent multimedia exchange with one or more self-correcting and collaborative properties being distributed, in accordance with one embodiment of the present invention.

FIG. 39 is a flowchart of a method for call hunting using a caller's hunting list for a system to serve as an independent multimedia exchange with one or more self-correcting and collaborative properties being distributed, in accordance with one embodiment of the present invention.

FIG. 40 is a front perspective view of a user interface for call hunting in a system to serve as an independent multimedia exchange with one or more self-correcting and collaborative properties being distributed, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

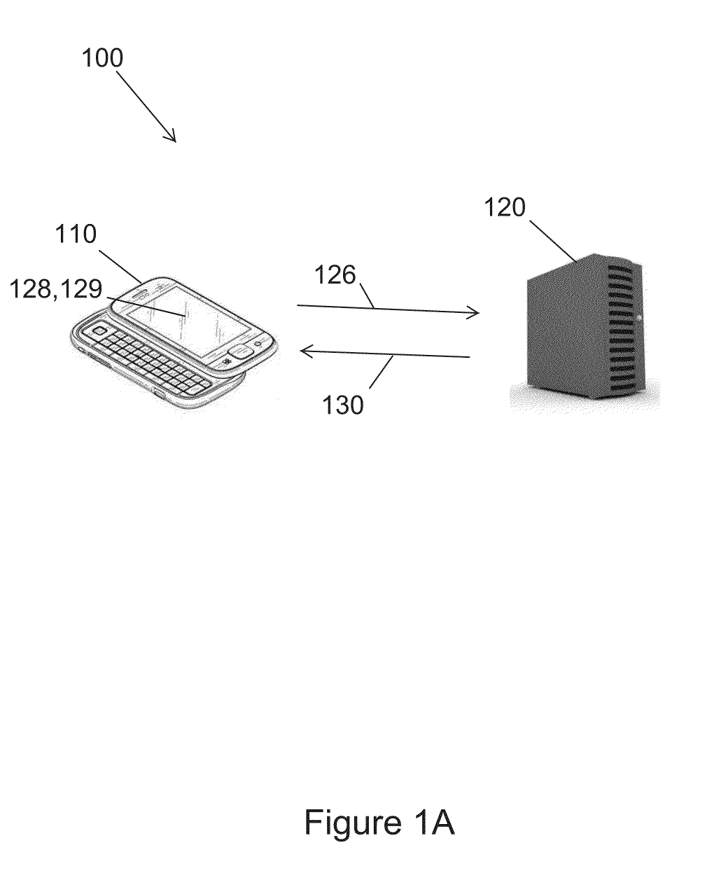

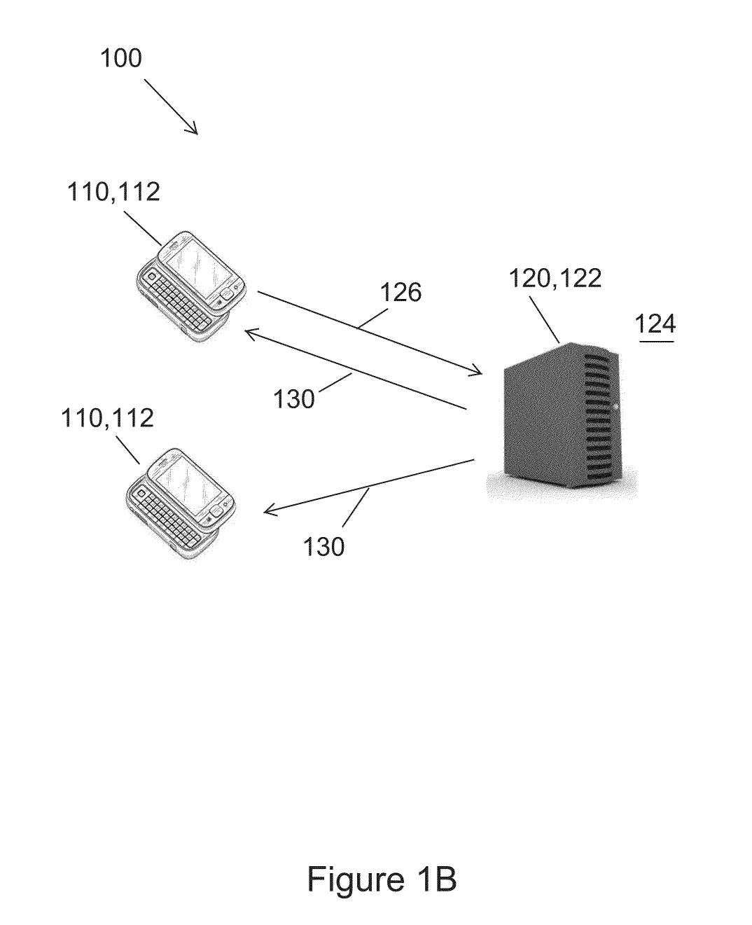

FIG. 1A illustrates a system overview of a system 100 to serve as an independent multimedia exchange with one or more self-correcting and collaborative properties being registered and preloaded, in accordance with one embodiment of the present invention.

The system 100 includes an intelligent call processing agent or ICAP agent 110 and an intelligent call processing engine or ICAP engine 120. The ICAP agent 110 is a software portion of a mobile device 112 that can also process and control signaling and media processing. The mobile device 112 can be any suitable mobile device such as a cellphone, a smartphone, a tablet computer or a laptop computer. The ICAP engine 120 is a server system 122 located in a computer cloud 124. Every time a user wants a certain feature, the user uses a user interface or UI 128 such as a graphical GUI 129 based call processing editing program which produces a script called an alternative call processing script or ACPR 126. The ACPRs 126 are processed by the ICAP engine 120.

FIG. 1B illustrates a system overview of a system 100 to serve as an independent multimedia exchange with one or more self-correcting and collaborative properties being distributed, in accordance with one embodiment of the present invention.

The system 100 illustrated and described in FIG. 1B utilizes a similar system 100, ICAP agent 110 and ICAP engine 120 illustrated and described in FIG. 1A. The system 100 specifically illustrates the ICAP engine 120 distributing one or more filter and routing scripts or FRSs 130. The ICAP engine 120 creates one or more FRSs 130 that are instructions which are XML based instructions executed at the ICAP agent 110 and are transmitted to all intended ICAP agents 110. The ICAP engine 120 provides all basic FRSs 130 and configures the ICAP agent 110. The ICAP engine 120 can understand the one or more FRSs 130 and will start executing the one or more FRSs 130. Basic features such as calling, broadcasting, unicasting and texting one user to one or more users in video, audio or text mode are part of the ICAP engine 120 basic features. The ICAP engine 120 also has capabilities to use GPS, audio speakers, video accelerators, cameras, accelerometers, timers and other sensors, signaling information or any feature that is present in the mobile device 112. Every time a call is made with the mobile device 112 that includes a basic property based call or a complex call (a call with business logic), an ICAP agent 120 checks for one or more built-in or preloaded FRSs 130 if they exist or creates an ACPR 126 and sends the ACPR 126 to the ICAP engine 120. The ICAP agent 110 requests an ACPR 126 with the ICAP engine 120. The ICAP agent 110 is a virtual machine which can read one or more FRSs 130 and execute a multimedia call. The one or more FRSs 130 are a set of instructions which is executed by the ICAP agent 110. The one or more FRSs 130 can manipulate basic features to provide user defined features. The one or more FRSs 130 are attached to itself and to other contacts information in the mobile device 112. The one or more FRSs 130 are a XML script given to each mobile device 112 as a part of the contact's presence information. The ACPRs 126 are processed by the ICAP engine 120, which is a server system 122 located in a computer cloud 124.

Since every user behaves like a multimedia exchange where an ICAP agent can process calls and media as per the FRS provided to the ICAP agent by the ICAP engine, the FRS which is transferred to a multiple mobile device for determining criteria, makes these mobile devices operate as a virtual single server. Even though these mobile devices are physically separate, the ICAP agents work together to provide a virtual cloud server environment. The virtual cloud server will execute the functionality of the user, by distributed and systolic computing by these mobile based ICAP agents.

The system to serve as an independent multimedia exchange with one or more self-correcting and collaborative properties solves the problem of maintaining huge infrastructure for multimedia exchange by eliminating centralized multimedia exchange. Every mobile can act as a multimedia exchange and start creating feature as per the needs of the user. For example, a mobile device can independently perform desktop sharing with other mobile devices and at the same time send a one way voice message to annotate or comment on a shared desktop without any centralized multimedia exchange service provider.

With the system innovation multimedia automation can be executed based on unlimited user defined logic and perceptions. Every mobile device has an independent exchange processing unit, which shall allow the mobile device to independently function as per the user needs and start a communication intended by the user. Since there is no centralized multimedia service provider, the features of the mobile device are unlimited as the multimedia processing is local. Unlike the existing multimedia exchange systems, the services are limited due to scalability problems.

A multimedia service includes audio broadcasting, video broadcasting, GPS based audio and video broadcasting, audio video calling and conferencing, sending audio and video messages based on an event or an instance such as recording a video and transmitting it to another user only at a particular time or when another user is at a particular location. With the system a user can decide how to communicate with their mobile device to other users. In an existing mobile device, a multimedia system user can use only those services allowed or published by the multimedia service provider. However with the system, every user can define their own plurality of services and features.

The system creates a new environment in which:

User does a plurality of multimedia calls in a way desired by the user

User can automate their multimedia communication

User can converge business logic with the multimedia calls

User chooses how to define and handle multimedia calls.

The FRS is given by an ICAP engine and is responsible for FRS script writing. Every FRS is a feature that a user requires or intends for his multimedia call. The ICAP engine writes these scripts and provides this to the ICAP agents where a call is normally handled or routed. The ICAP agents are present in one or more mobile or end user devices or intermediate servers which filter events and perform call processing based on the FRS. The ICAP agents convert user multimedia call intents to an ACPR or an alternative call processing request. The ICAP engine gets input from a plurality of ACPRs, which are created by users by the GUI interface from their end user devices.

An example of an ACPR is when Kate gets a call from Tom. Kate intends to forward the call to Jerry and at the same time record the discussion and send it to Kate's mobile device. This happens without a centralized server as the server functionality is converted as a FRS and distributed to Kate's, Tom's and Jerry's ICAP agents. This is a deviation of an existing call processing logic which is why the ICAP is an alternative call processing request. The ACPR is sent to an ICAP engine to validate and verify the ACPR, to make sure all call parties accept the logic and creates a FRS and that is sent to affected mobile device's ICAP agents. The ICAP engine monitors an execution of the FRS by its agents. The ICAP engine is a server that resides in a presence server. The FRS is a script which can change the behavior of an ICAP client before execution of a FRS takes authorization, user authorization and device resources authorization also takes an audit of the system, to see how far the mobile device is capable of performing the FRS. The user sends the ACPR to the ICAP engine and the ICAP engine sends the FRS to the ICAP agents and the ICAP agents modify the call processing and implement the alternative call processing. The ACPR is a user representation of one or more calling or multimedia communication features and the FRS is instruction given to the ICAP agents to execute the desired ACPR. The FRS may be different for different mobile devices even though it may be for the same behavior, but the ACPR definitions always are the same as it deals with user behavior. A client originates a request which is an ACPR and this request is sent to the ICAP server before acknowledging the client sends the FRS to all the clients where the call processing happens. The ICAP engine knows the status of each and every client and the FRS is executing the status of every client as well. Every FRS is very transparent to every user and a user notification is given before executing any FRS. A user can always deny a FRS if it affects his or her capability. The FRS when executed in one or more clients is to execute an alternative call processing.

ACPRs are categorized as an individual ACPR which will affect the individual who is issuing an ACPR 2 and a third party accepted where a third party client is affected. Individual ACPRs are always checked for race conditions only, but third party ACPRs have to be approved by the user and work one time based on repetitive approval. The ICAP engine has to monitor that an ACPR does not affect any other ACPR issued by someone else to cause a loop or race condition or neutralize other ACPRs given by third parties. An ACPR issued should not affect the overall ecosystem of call processing. The ACPR is derived from a touch based interface, called Quad. Quad is a GUI interface and is either a menu based interface or a touch based interface and can be accomplished by interactive voice response or IVR as well. Quad can generate an ACPR and is verified by an ICAP agent for syntax and by an ICAP server for logic and system integrity.

ACPRs and FRSs are a XML and are sent thru a web service and heartbeats. Heartbeats are periodic events that an ICAP client sends to an ICAP engine. An ICAP engine can respond to a heartbeat with an FRS along with presence and other signaling information. Every FRS is acknowledged and the client ICAP agent gives a log on when the FRS was executed. This is a relatively tight system with collaboration of tightly coupled, call processing which is defined as flexibility. A FRS which was not executed is called a missed burst and it is acceptable for a FRS to not get executed. But the impact that occurs because of not executing the FRS should be caught by the ICAP agents that are in another mobile device. An ICAP agent after giving an ACPR also know what kind of missed burst it can get and how to handle them. For example when a user says whenever I get a call from user B, divert to user C. If user B has a missed burst, then user B will send a call request to user A, which will catch it and send a missed burst indication to user B. This also means the user B ICAP agent was faulty.

When user A gives an ACPR request for a call diversion from user B, then the ICAP engine should know what are all the ACPRs that should not be accepted after the FRS to execute the ACPR is given. Now if user C sets an ACPR saying any call from user B should be diverted to user A, this would cause an eternal loop. When user C sets such an ACPR then the ICAP client will not allow user C to set this ACPR. The ICAP agent will not get a nod from the ICAP engine to set such an ACPR.

Some of the advantages of the system include:

1. Every user can have a desired multimedia calling and multimedia communication feature without a centralized service provider.

2. A user can have a custom defined communication mechanism such as a user recording a video and sending it to another user at an appropriate time or an event such as at a GPS location or when receiving an incoming call.

Since every user behaves like a multimedia exchange where an ICAP agent can process calls and media as per the FRS provided to by the ICAP engine, the above uses can be achieved.

The FRS is transferred to one or more multiple mobile devices for criteria, which makes these mobile devices a virtual single server. Even though these mobile devices are physically separate, the ICAP agents work together to provide a virtual cloud server environment. The virtual cloud server will execute the functionality of the user, by distributed and systolic computing by these mobile device based ICAP agents.

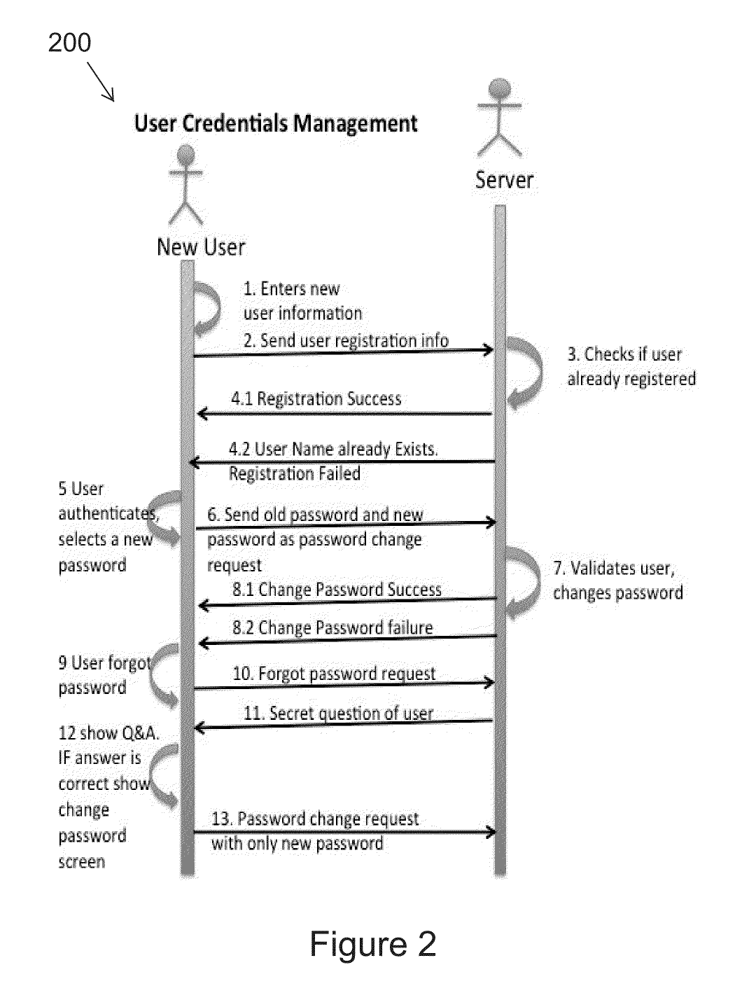

FIG. 2 is a flowchart of a method 200 for a user creating a new user ID in a system to serve as an independent multimedia exchange with one or more self-correcting and collaborative properties being distributed, in accordance with one embodiment of the present invention.

The flowchart of a user creating a new user ID 200 allows a user to create a new user password as well as allow a user to retrieve a forgotten password and change a password. A user enters details for creation of a user ID that includes a username, a password, an e-mail ID, a secret question and answer and other suitable information. Details are sent to the server and the server checks if the user ID exists already. If yes, a rejection response is sent and a user ID is created and a success response is sent back to the user. If the user wishes to change the password, the user clicks on the change password option, types and retypes the new password. The old password and the new password are sent to the server and the server authenticates the user and marks the changed password. If authentication fails, a change password failure response is sent back to the user and if the user has forgotten the set password, the user clicks on the forgotten password and the request is sent to the server. Details of the secret question and response are sent as a response from the server and the user enters the answer to the secret question. If the answer is correct, the user is authorized and is allowed to change his password, if the answer is wrong, the user cannot change his password. In case the server is not reachable or the network is not available during the process, abort messages are shown to the user and the operation is aborted. The flowchart of a user creating a new user ID 200 checks if the user enters one or more mandatory fields and checks if the user types and retypes the password correctly. The flowchart of a user creating a new user ID 200 also includes if a minimum length criteria is met for the user ID and password.

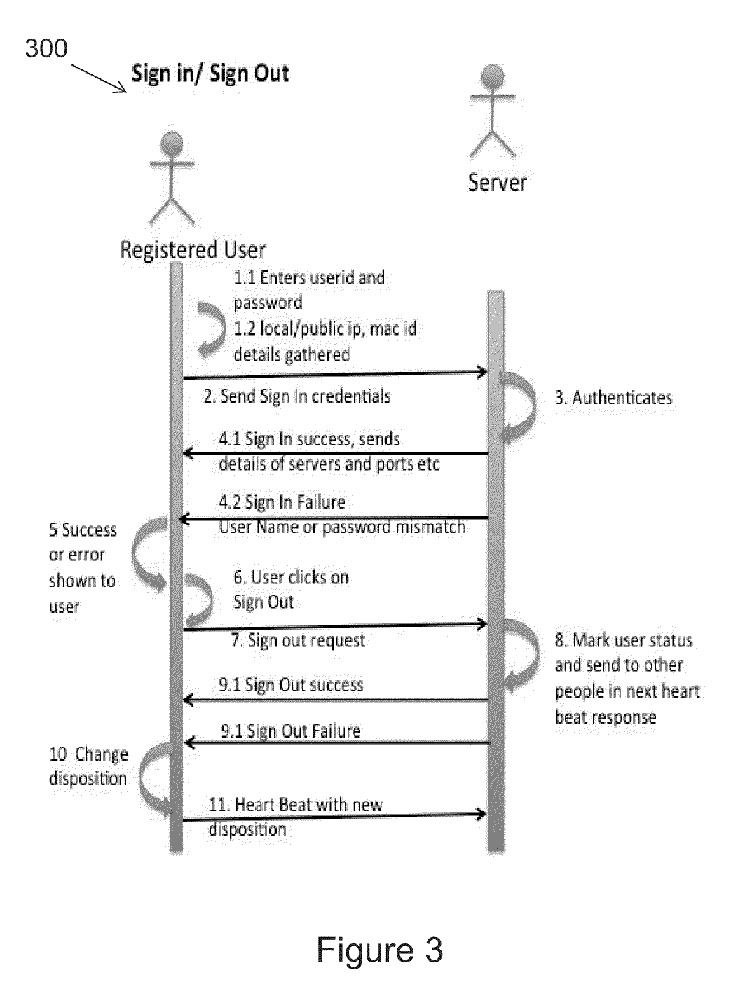

FIG. 3 is a flowchart of a method 300 for a user signing in and logging out of a system to serve as an independent multimedia exchange with one or more self-correcting and collaborative properties being distributed, in accordance with one embodiment of the present invention.

The flowchart of a user signing in and logging out 300 allows a user to sign into the flowchart of a user signing in and logging out 300 with a valid user ID and password and log out as desired. The flowchart of a user signing in and logging out 300 also allows the user to change their disposition. The user enters a user ID and password onto the login screen and a sign-in request is sent to the server with the details of the user. The server authenticates the user and if the user is a valid user, a success response is sent back to the user with details of a server port number. In case authentication fails, the server sends a sign-in failure response. When the user wishes to sign out of the application, the user sends a sign out request with the user ID and the password. The server authenticates the user and marks the disposition of the user. If authentication fails, server sends a “Sign out” failure response. The user can change disposition any time while logged into the system. Details of the disposition are sent to the server along with a heartbeat and the server marks the user's disposition for use by the other buddies. In case the server is not reachable or the network is not available during the process, one or more abort messages are shown to the user and the operation is aborted.

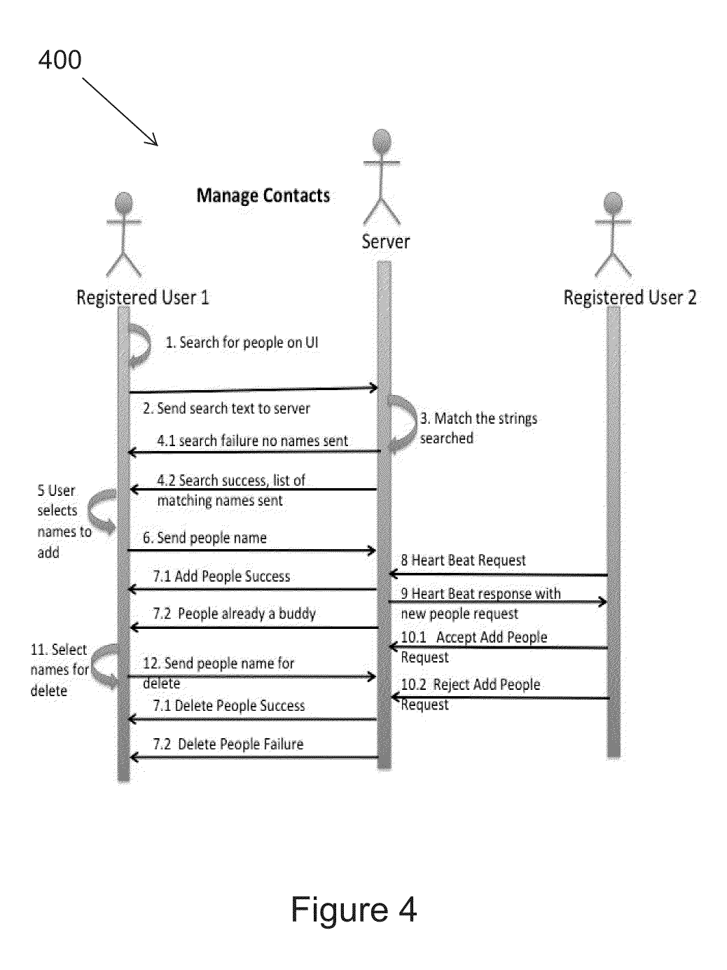

FIG. 4 is a flowchart of a method 400 for a user managing contacts in a system to serve as an independent multimedia exchange with one or more self-correcting and collaborative properties being distributed, in accordance with one embodiment of the present invention.

The flowchart of a user managing contacts 400 can search for people and add or delete people from a list of buddies once a user is logged-in. The user goes to the search screen and types in the names of the people being searched for. A search people request is sent to the server with a string pattern. The server checks the people database and responds back with the list of people matching the search criteria. If no match is found a failure response is sent back to the user and from the list of all matching entries, the user can select one or more people to add as a buddy. An add people request is sent to the server with details of the selected buddy. The server places a new buddy request against the selected people names and sends an add buddy success response to the user. In case the selected people or person is already a buddy of the user, an add buddy failure response is sent back to the user. The buddy request is carried by the requested people as part of their heartbeat response. Requested people can choose to accept or reject the user as a buddy. At any point in time the user can choose to delete one of the people from the people list by selecting a buddy and clicking on delete where a delete people request is sent to the server. The server verifies and marks the people as being “Not a buddy” of the user. In case the deleted person's name is not a buddy, a “Not a buddy”, delete people failure message is sent back to the user. In case the server is not reachable or a network is not available during the process, one or more abort messages are shown to the user and the operation is aborted.

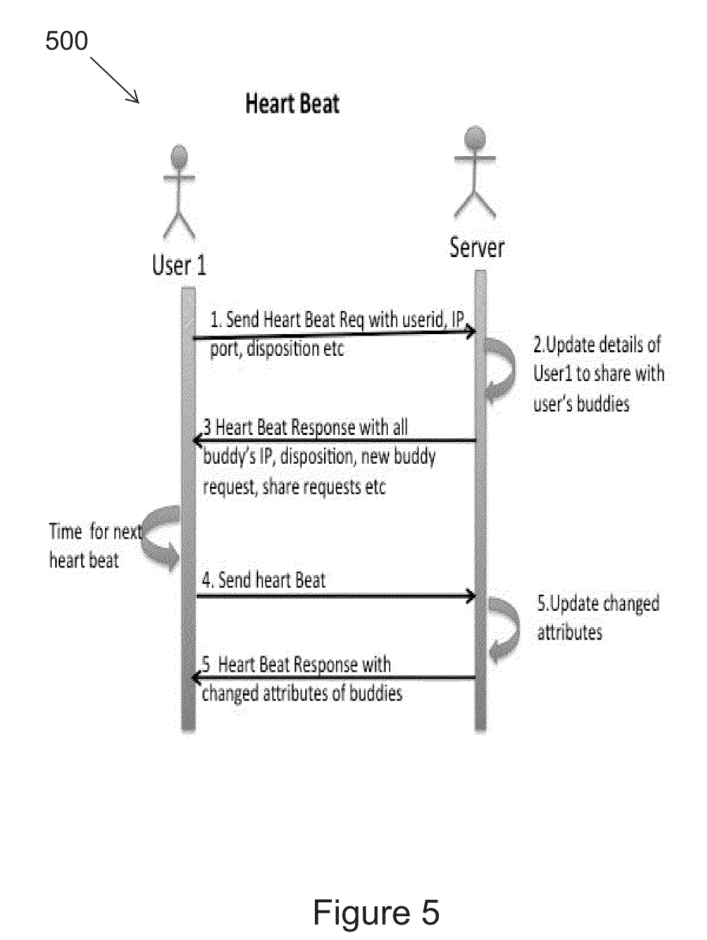

FIG. 5 is a flowchart of a method 500 for a heartbeat request in a system to serve as an independent multimedia exchange with one or more self-correcting and collaborative properties being distributed, in accordance with one embodiment of the present invention.

The user sends a heartbeat request periodically to the server to communicate any changes to his disposition or coordinates for communication. The user must be logged in and be a registered user. For a buddy to receive a user's attributes, the buddy must be considered a buddy of the user. When the user is logged in, the user sends a plurality of attributes like an IP address, a disposition and other suitable information to the server at predetermined intervals. The server marks any changes in attributes from the previous heartbeat and sends back a heartbeat response. The heartbeat response contains all the attributes of the user's buddies and is repeated while the user is logged in.

In case the server doesn't get a heartbeat response from the user 3 consecutive times, the server assumes there is a connectivity issue with the user and forces the user's disposition as logged off. In case the user doesn't receive any response from the server for 3 consecutive heartbeats, the client assumes either the server is offline or there is an issue in network connectivity and changes the user's disposition to offline.

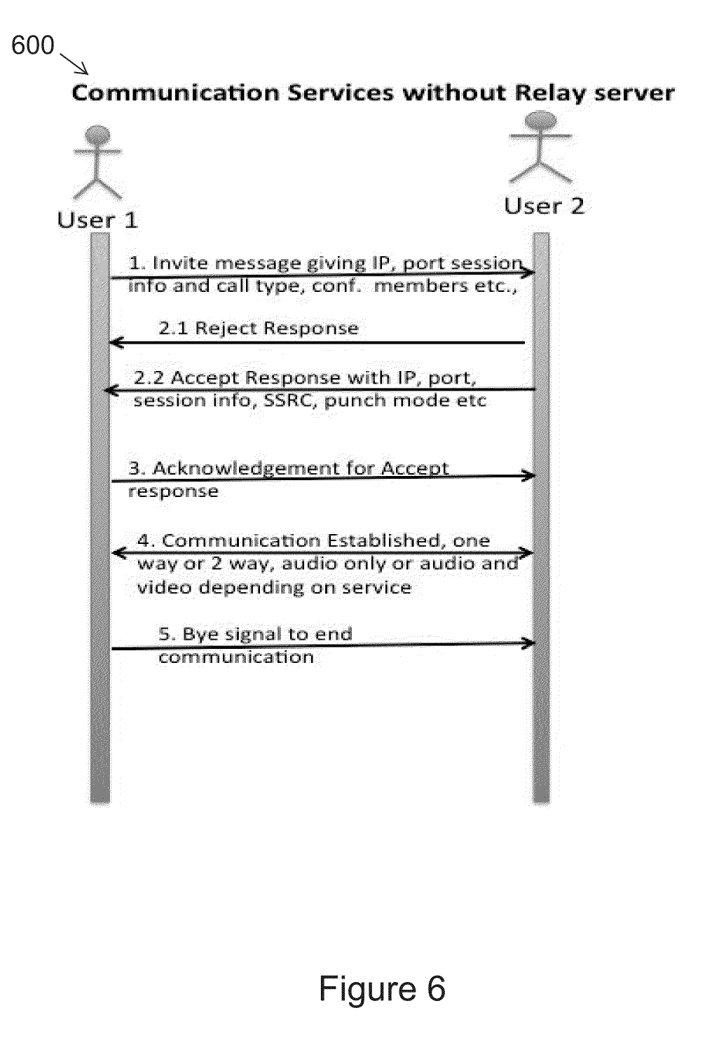

FIG. 6 is a flowchart of a method 600 of a user initiating a communication service without a relay server with one or more buddies in a system to serve as an independent multimedia exchange with one or more self-correcting and collaborative properties being distributed, in accordance with one embodiment of the present invention.

User 1 can initiate a communication service with one or more buddies. User 1 must be logged in and user 2 must have accepted user 1 as a buddy. When user 1 is logged in, user 1 can click on user 2 and initiate a communication service such as a chat, a unicast and chat or other suitable communication service. A chat initiation request is sent to user 2 along with user 1's coordinates for communication information like IP, port, service type and other suitable information. User 2 can accept the incoming communication by responding with the accept message. When user 2 rejects the incoming chat, a reject signal is sent back to user 1 and user 1 sends an acknowledgement for an accept signal. Communication is established between user 1 and user 2. In case of unicast, it is a one way communication or in a chat it is a two way communication. Similarly the media of communication can be audio, video, text or GPS depending on the service initiated. To hang up and end the service, a good-bye signal is sent by one of the users and the channels for communication are closed on both ends.

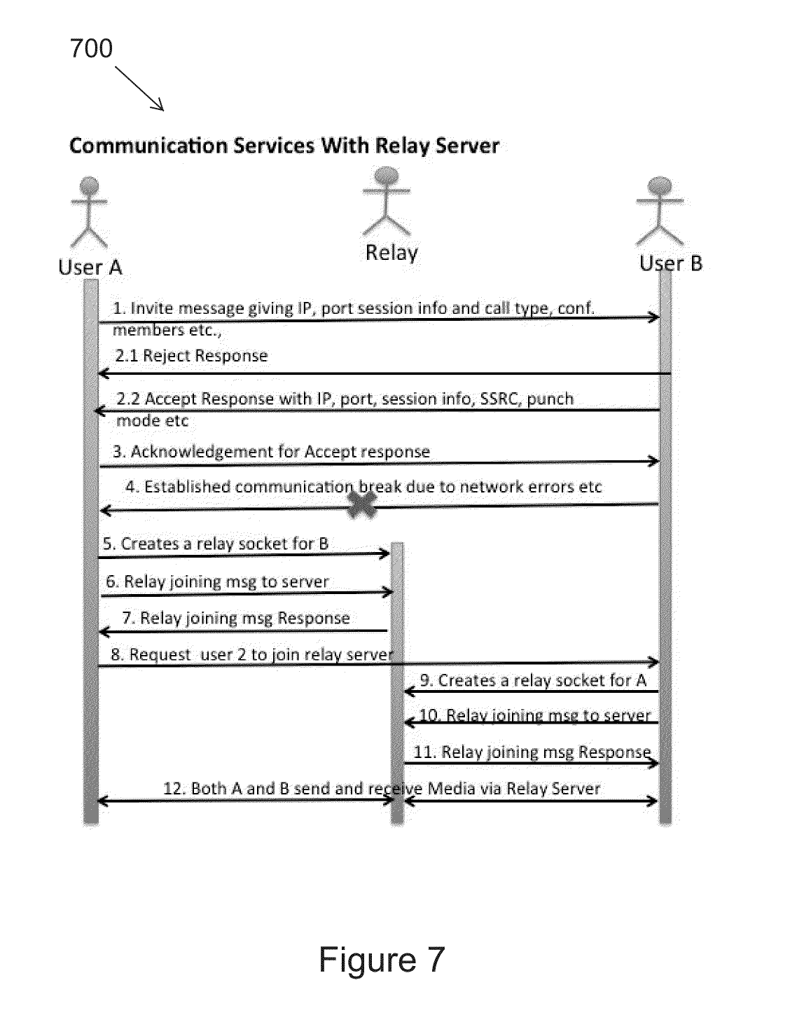

FIG. 7 is a flowchart of a method 700 for a user initiating a communication service with a relay server with one or more buddies in a system to serve as an independent multimedia exchange with one or more self-correcting and collaborative properties being distributed, in accordance with one embodiment of the present invention.

In case the service involved is a conference, the list of people in conference is also sent in an invite request. User 2 then establishes communication channels with each of the people in the conference as well. In case one user is unable to receive any media from the other user due to network error or other suitable error, it alternatively routes the media through the media relay server. The media capability of the sender while making a service is checked. For example, user 1 is checked for a video camera before allowing a videoconference to start.

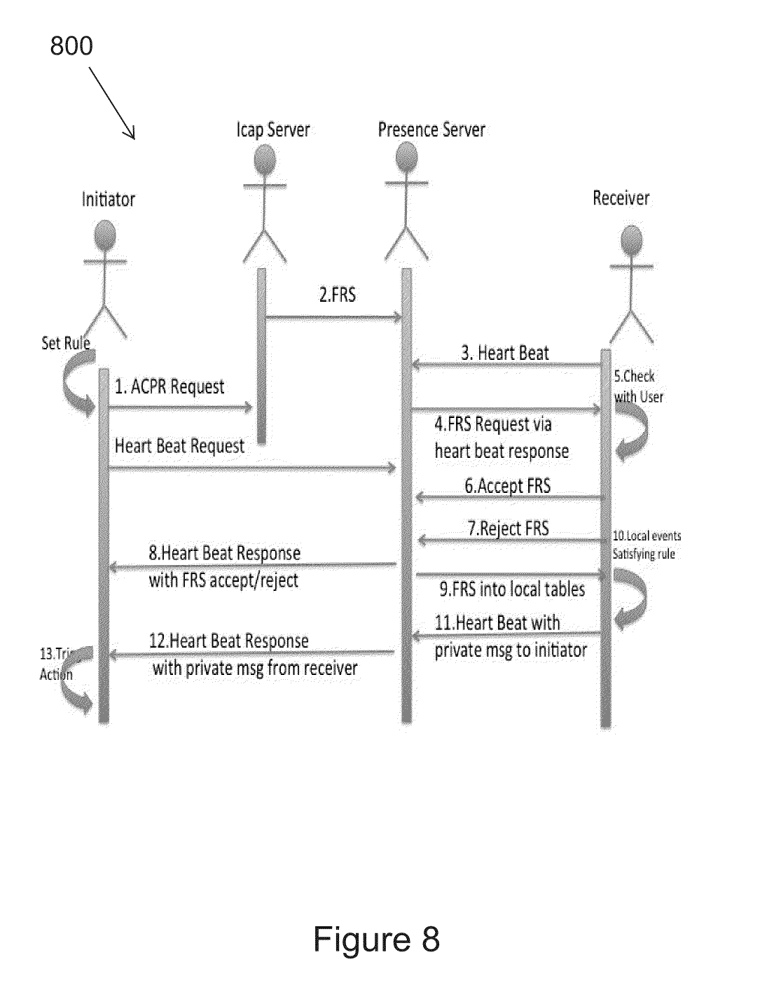

FIG. 8 is a flowchart of a method 800 for a user communicating with one or more buddies based on a rule in a system to serve as an independent multimedia exchange with one or more self-correcting and collaborative properties being distributed, in accordance with one embodiment of the present invention.

User 1 must be logged in and user 2 must have accepted user 1 as a buddy. An initiator sets a rule locally on a client device using the rule based communication user interface. An ICAP agent on the client device checks if an ACPR is required or if the communication can be achieved locally. If intervention of the ICAP agent is required, an ACPR is composed and sent to the ICAP server. The ICAP server generates an FRS and writes into a database of a presence server. The presence server gives the FRS to the receiver during the next heartbeat response. If the receiver's approval is required for the FRS execution, the receiver sends a response in the next heartbeat to the presence server. The presence server communicates the response to the initiator and places a copy of the FRS into the database of the receiver. The receiver monitors events locally and when the conditions are met, sends a private message to the presence server as part of the heartbeat. The initiator gets information requested from the receiver as part of the heartbeat response. In the event of failure from the receiver's side to meet the FRS, the presence server posts one or more error notifications to the initiator. In case the rule set by the user doesn't need approval or action by the third part, a local rule is set and it is executed when the relevant events are triggered.

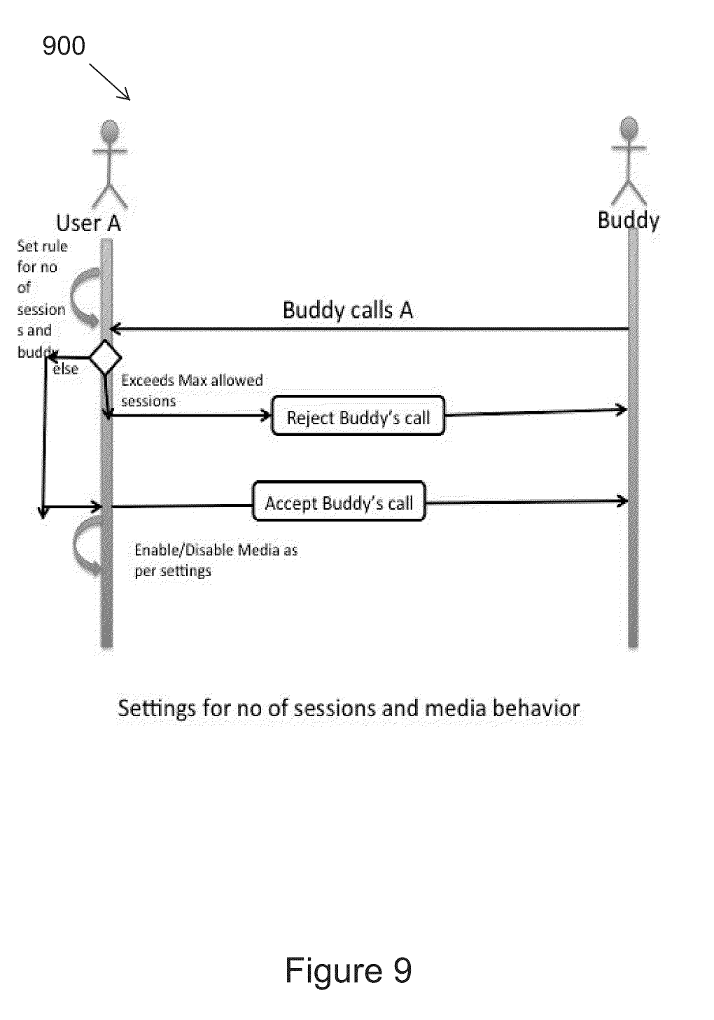

FIG. 9 is a flowchart of a method 900 for a plurality of message sequence calls in a system to serve as an independent multimedia exchange with one or more self-correcting and collaborative properties being distributed, in accordance with one embodiment of the present invention.

User A is unicasting user B and user C which can unicast user D. User A can unicast user B as long as user A and user B settings allow (settings for multiple sessions and services configuration). User B can unicast user A as long as user A and user B settings allow (incoming and outgoing settings for multiple sessions and services configuration). If multiple session settings or service configuration settings do not allow a user to make a unicast, alert messages are shown before starting the service. Similarly if the receiver is not able to accept the service because of the limitation, one or more negative responses are sent and the chat is not connected.

User A can unicast user B at the same time user C can also unicast user B and user B has the option to choose the session or the media user B wants to hear, with no rule. User A unicasts user B. User B can receive the unicast as long as the media settings in user B preferences and settings doesn't prevent user B from receiving the unicast. User C unicasts user B. User B can receive the unicast as long as the media settings in user B preferences do not prevent user B from receiving the unicast and the number of allowable parallel sessions is not exceeded. While the unicast is in progress, user B has the option to mute or listen to any of the unicasts currently received. No new user interface or UI is needed.

User A can also set how many sessions can be received at the same time and how the media should react, based on the buddies and a local rule. User A goes to the settings screen and clicks on media settings. User A enters the number of allowable parallel sessions and which sessions would like to be received in parallel. User A enters how the media should behave when the allowable number of parallel sessions has been exceeded. User A can also set how the media would like to be conducted while communicating to a buddy, for example, when user A receives video chats from user B, do not show me his video. Warnings are given to user A while the allowable number of parallel sessions is entered depending on the device capabilities about expected deterioration and performance.

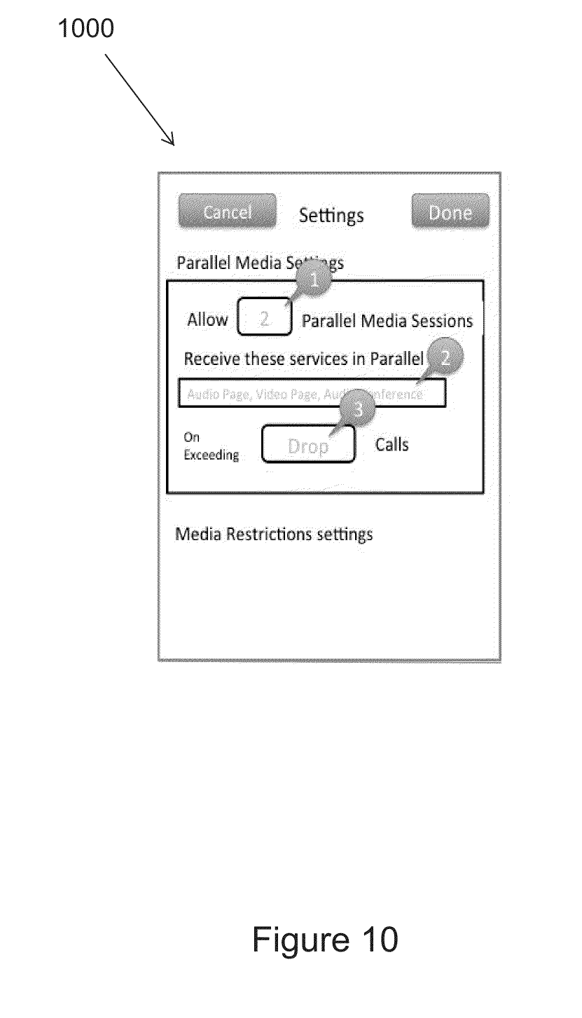

FIG. 10 is a front perspective view of a user interface 1000 with a plurality of media settings utilized in a system to serve as an independent multimedia exchange with one or more self-correcting and collaborative properties being distributed, in accordance with one embodiment of the present invention.

After a user enters a plurality of parallel media settings, one or more warnings will be displayed on the user interface if deterioration is expected in performance. The user will be able to select one or more services from a list of all available services. Options available on the user interface are drop, record, audio, video and mute. However, only one option can be selected at a time.

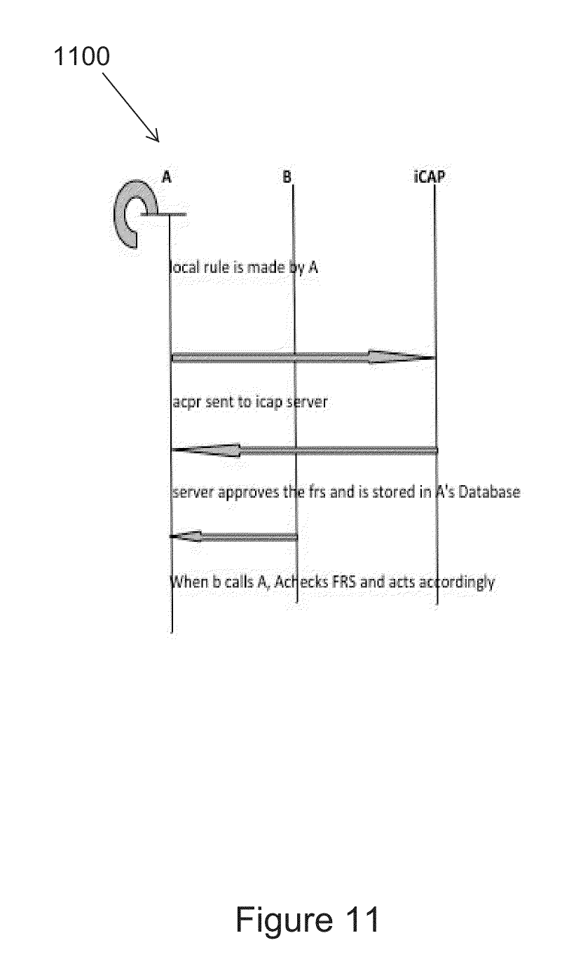

FIG. 11 is a flowchart of a method 1100 for performing one or more media settings in a system to serve as an independent multimedia exchange with one or more self-correcting and collaborative properties being distributed, in accordance with one embodiment of the present invention.

A user can set how many one way paging sessions can be received at the same time and how the media should react, based on one or more local events or ICAP events. The number of sessions a user can receive per service can be set as a local rule. Services a user can receive simultaneously can be set as a local rule. Every user should be able to set the following:
1. Mute Audio
2. Mute Video
3. Mute text and transactional parameters
4. Mute share screen.

A user sets the number of services received that can be received at the same time, sets the number of sessions per service a user can receive at the same time and fills in settings for muting services.

The method 1100 for performing media settings goes to the settings screen and clicks on media settings. A user sets a local rule for a number of parallel services, a number of sessions per service and mute for services. The local rule is stored in the FRS and every time an incoming service happens, the rule is checked in the FRS and the FRS acts accordingly. If the maximum number of services or session per service isn't reached, the rule allows the incoming service. If the maximum number of services or sessions per service is exceeded, the incoming chat will be automatically denied to the initiator and engaged tone is set. The user interface will not be shown to the receiver as the rule is already set.

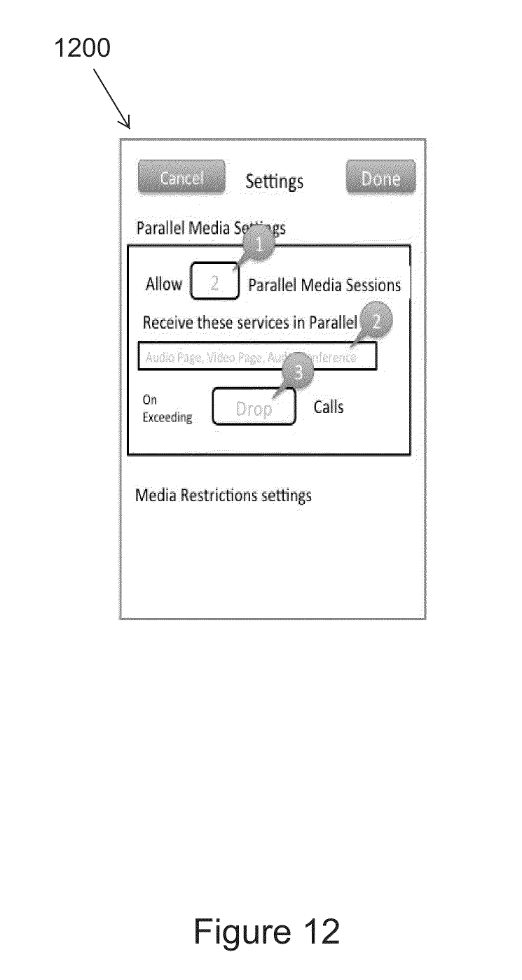

FIG. 12 is a front perspective view of a user interface 1200 with a plurality of parallel media settings utilized in a system to serve as an independent multimedia exchange with one or more self-correcting and collaborative properties being distributed, in accordance with one embodiment of the present invention.

After a user enters a plurality of parallel media settings, one or more warnings will be displayed on the user interface if deterioration is expected in performance. The user will be able to select one or more services from a list of all available services. Options available on the user interface are drop, record, audio, video and mute. However, only one option can be selected at a time.

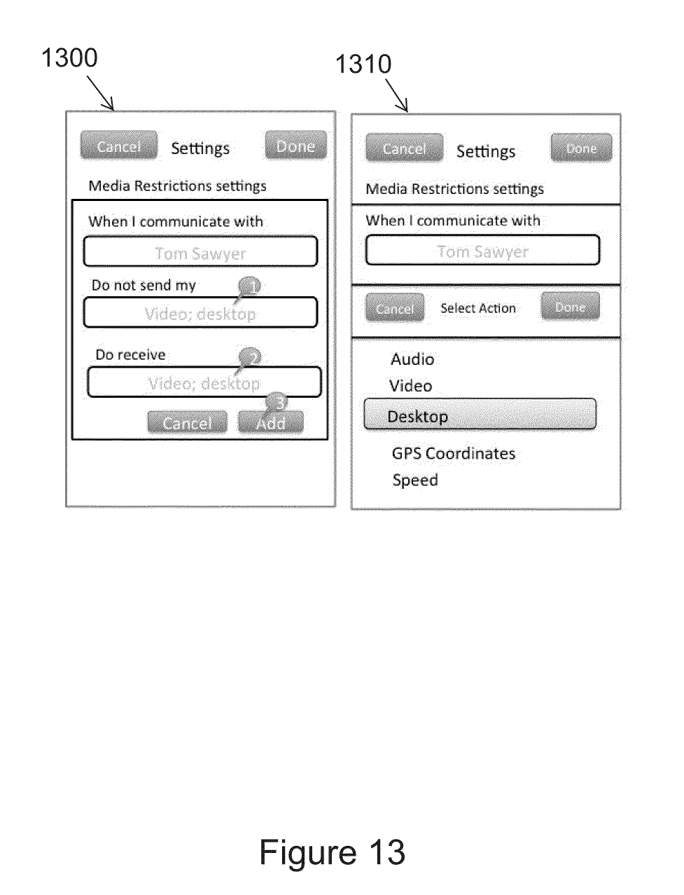

FIG. 13 is a front perspective view of a pair of user interfaces 1300, 1310 with a plurality of media restriction settings utilized in a system to serve as an independent multimedia exchange with one or more self-correcting and collaborative properties being distributed, in accordance with one embodiment of the present invention.

The pair of user interfaces 1300, 1310 can block out going media, block in coming media and add similar restrictions for more buddies.

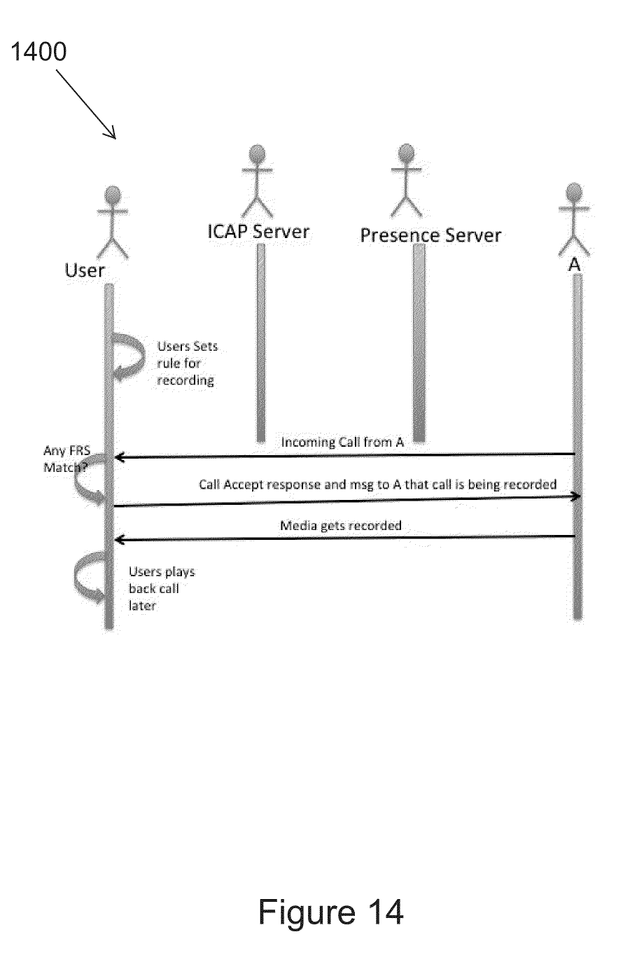

FIG. 14 is a flowchart of a method 1400 for performing recording media and playing the media later in a system to serve as an independent multimedia exchange with one or more self-correcting and collaborative properties being distributed, in accordance with one embodiment of the present invention.

A user has an option to record and play a recorded media later. The user should have set the options in the settings screen of a user interface. A user creates a rule for the specific conditions. When an incoming chat event happens, an FRS is checked. If there is a rule set, the chat gets recorded and marked as unread. When the user interacts with the application later there will be provided a visual notification of a new unread chat recording based on which user can playback the recorded message.

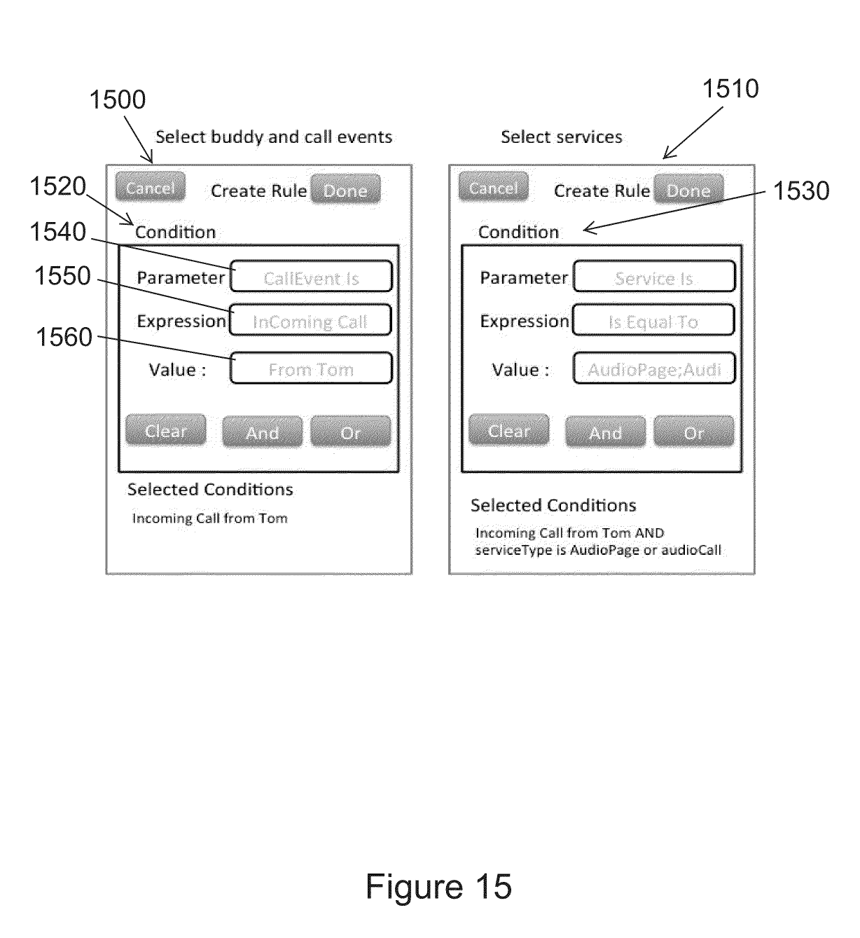

FIG. 15 is a front perspective view of a pair of user interfaces 1500, 1510 with a plurality of select buddy and call events settings 1520 and a plurality of select services settings 1530 utilized in a system to serve as an independent multimedia exchange with one or more self-correcting and collaborative properties being distributed, in accordance with one embodiment of the present invention.

Both the select buddy and call events settings 1520 and the select services settings 1530 include a parameter setting 1540, an expression setting 1550 and a value setting 1560.

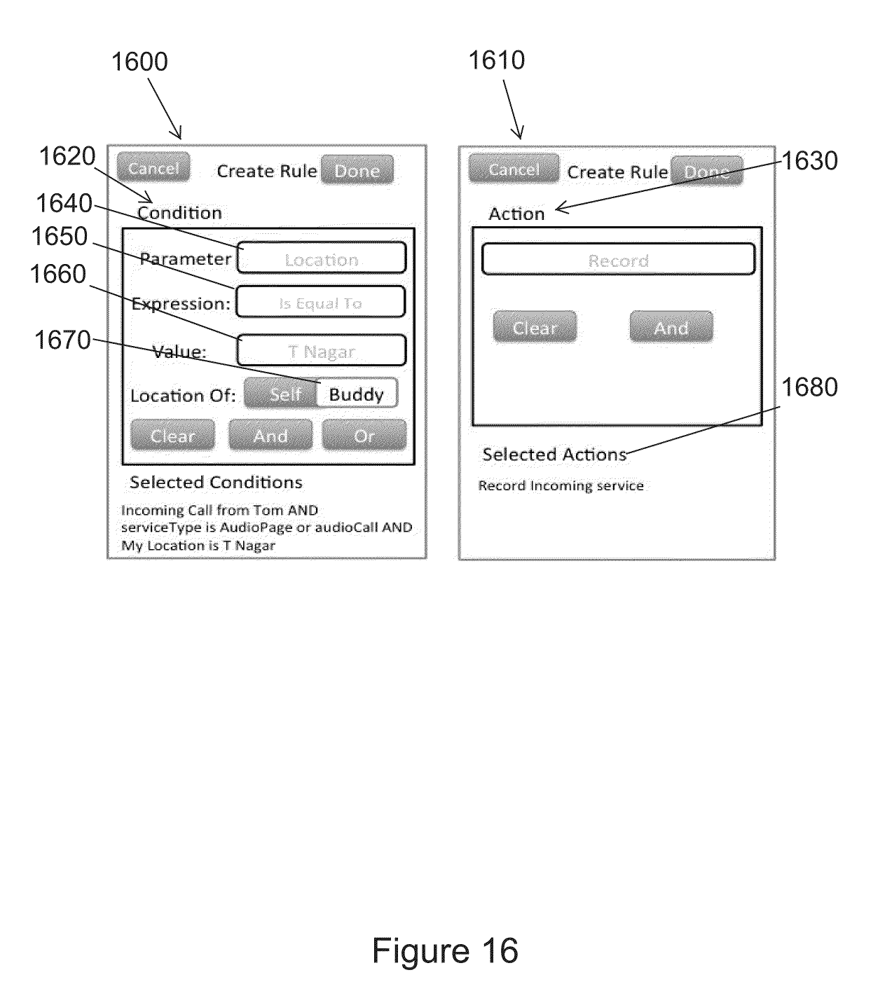

FIG. 16 is a front perspective view of a pair of user interfaces 1600, 1610 with a plurality of selected conditions settings 1620 and a plurality of selected actions settings 1630 utilized in a system to serve as an independent multimedia exchange with one or more self-correcting and collaborative properties being distributed, in accordance with one embodiment of the present invention.

The selected conditions settings 1620 include a parameter setting 1640, an expression setting 1650, a value setting 1660, and a location of setting 1670. The selected actions settings 1630 include one or more selected actions 1680.

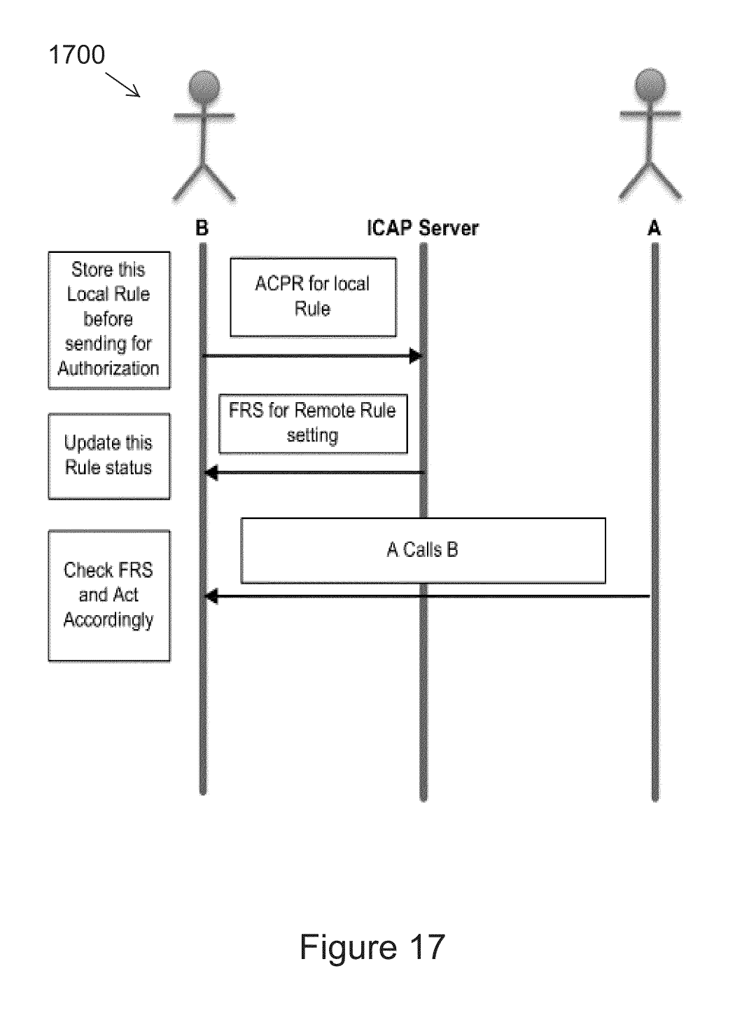

FIG. 17 is a flowchart of a method 1700 for performing a location based rule setting in a system to serve as an independent multimedia exchange with one or more self-correcting and collaborative properties being distributed, in accordance with one embodiment of the present invention.

User A can unicast user B and user B can unicast user A at the same time. User A starts a unicast to user B. User B starts a unicast to user A forming a two way communication. User settings should be checked on both sender side as well as receiver side. If the user has prevented multiple sessions at the same time, appropriate messages will be shown to the users. No new UI is required and an existing UI for unicast will suffice.

User B can receive a unicast from user A only when user B is in a particular location, where user B is enforcing the rule. The location of user B should be available to user A to check the rule. If the location matches with the rule, then the unicast can be accepted. User B enforces that only when user B is in a particular location, it can receive a unicast from user A, or the unicast is rejected. Every time, user B receives a unicast from user A, user B checks its FRS for any conditions. If the location matches, it accepts the unicast, or else rejects the unicast.

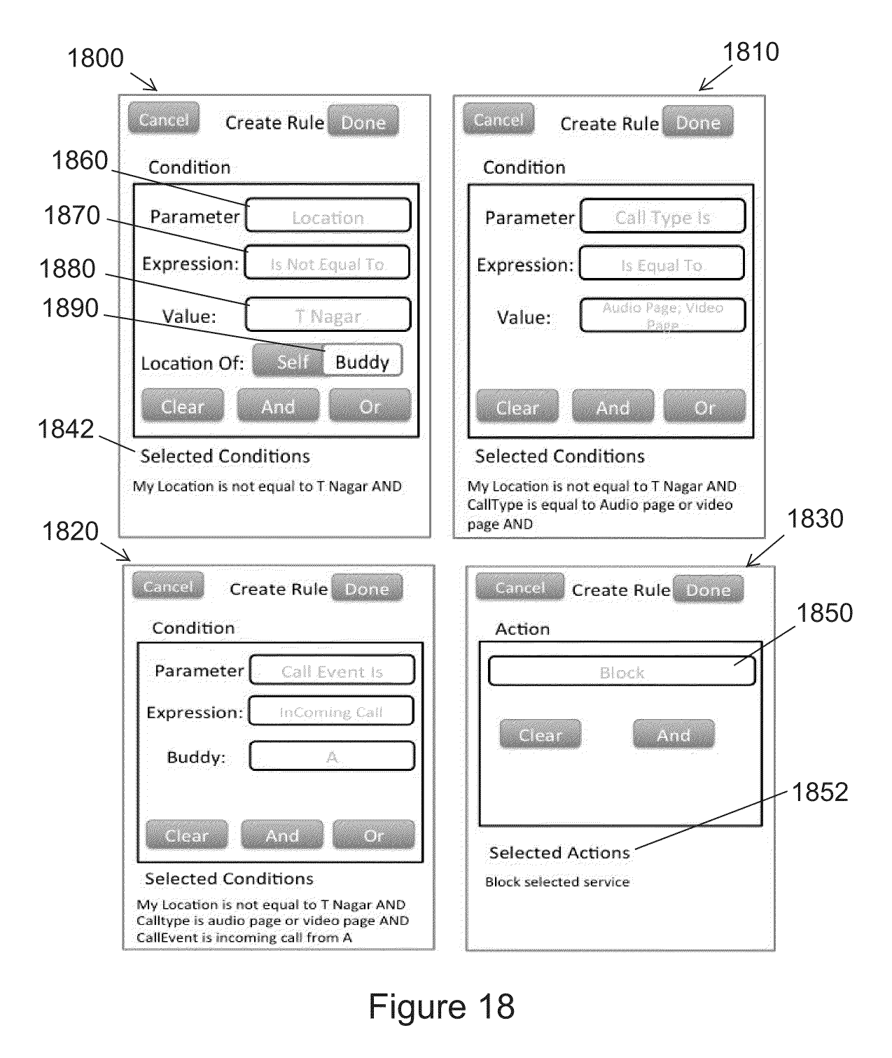

FIG. 18 is a front perspective view of 4 user interfaces 1800, 1810, 1820, 1830 with a plurality of selected conditions settings 1840 and a plurality of selected actions settings 1850 utilized in a system to serve as an independent multimedia exchange with one or more self-correcting and collaborative properties being distributed, in accordance with one embodiment of the present invention.

The selected conditions settings 1840 include a parameter setting 1860, an expression setting 1870, a value setting 1880 and a buddy setting 1890. A selected condition 1842 from the selected conditions settings 1840 is also provided. The selected actions settings 1852 can be any suitable action setting.

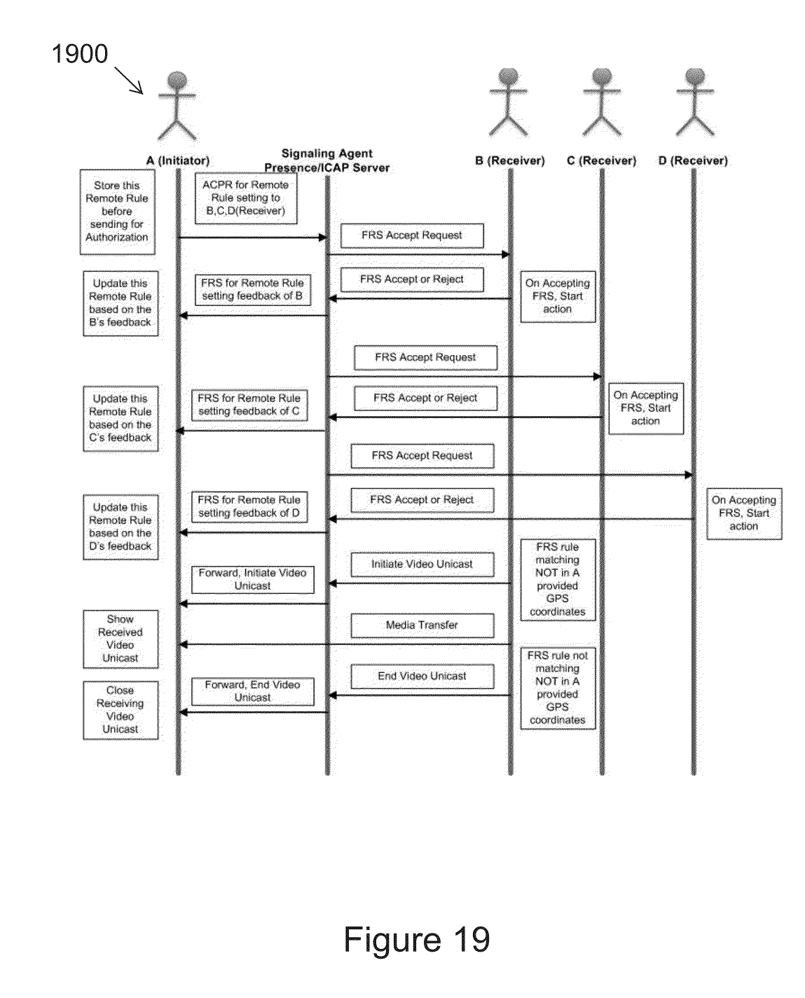

FIG. 19 is a flowchart of a method 1900 for enforcing one or more rules on a buddy in a system to serve as an independent multimedia exchange with one or more self-correcting and collaborative properties being distributed, in accordance with one embodiment of the present invention.

User A enforces that user B, user C and user D's videos are sent to user A when they are not in a set of GPS coordinates or routes. User A sets a remote rule to user B, user C and user D after authorization. User B, user C and user D stores the rule locally after accepting the same. When GPS coordinates not in condition matches, an automatic video unicast is initiated. When GPS coordinates not in condition fails, an automatic video unicast is ended.

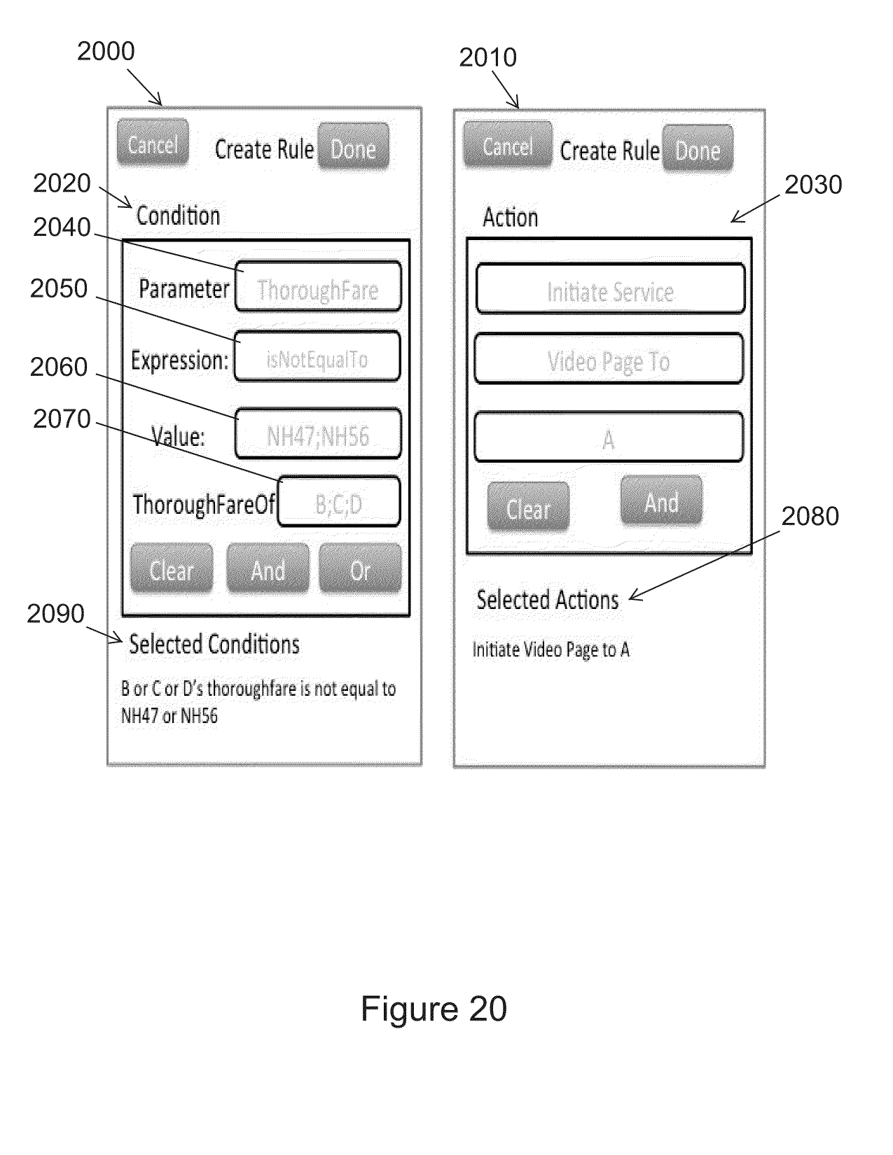

FIG. 20 is a front perspective view of a pair of user interfaces 2000, 2010 with a plurality of selected conditions settings 2020 and a plurality of selected actions settings 2030 for enforcing one or more rules on a buddy utilized in a system to serve as an independent multimedia exchange with one or more self-correcting and collaborative properties being distributed, in accordance with one embodiment of the present invention.

The selected conditions settings 2020 include a parameter setting 2040, an expression setting 2050, a value setting 2060, and a thorough fare of setting 2070. The selected actions settings 2030 include a plurality of selected actions 2080 such as initiate service, video page to a user and other suitable action settings. The selected actions 2080 and selected conditions 2090 are displayed on the bottom of the pair of user interfaces 2000.

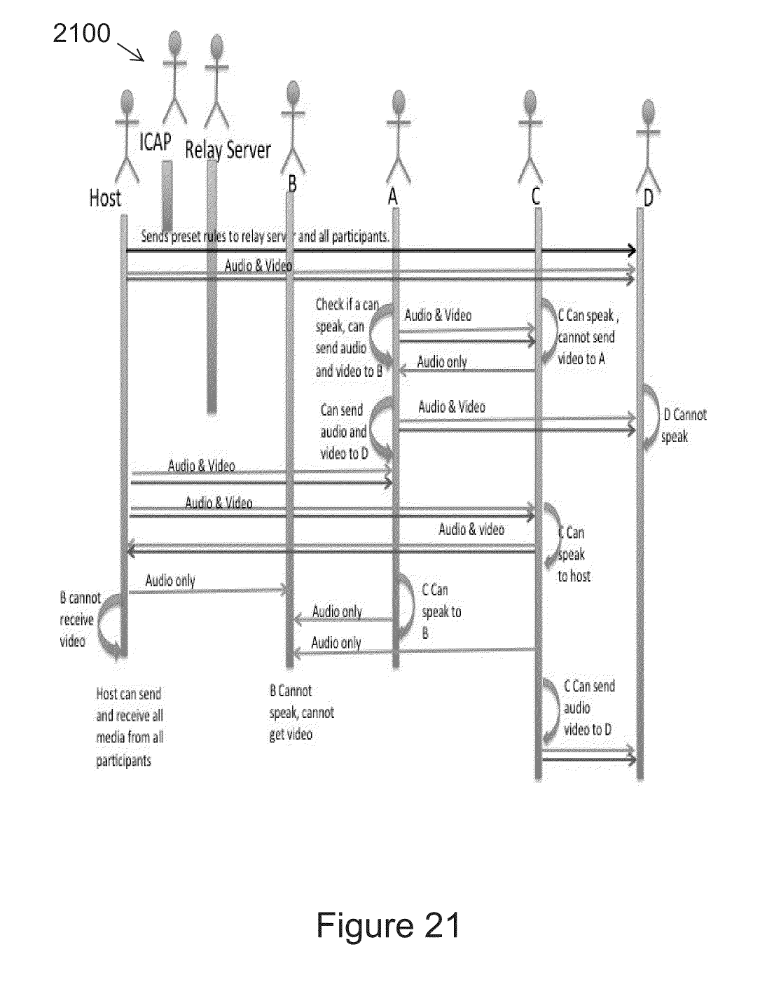

FIG. 21 is a flowchart of a method 2100 for establishing one or more dynamic media rules in a hosted conference in a system to serve as an independent multimedia exchange with one or more self-correcting and collaborative properties being distributed, in accordance with one embodiment of the present invention.

The method 2100 includes a conference defined host and set that can dynamically speak and that can hear without a rule. It should be also possible that one of the participant's talk and media can be heard and realized by a set of participants and not by all. Only selected users can talk at a time and only selected users can realize the selected media.

Host of the conference chat sets details of who can speak and what kind of media they can send or receive. Once chat is established, the rules are sent to all participants of the chat and the relay server so that the relay server is able to restrict the media realization in case media is routed through it. When user A communicates with user B, before sending audio and video, user A checks if the media can be sent to user B as well as if user B can receive the media. Only when a particular media can be sent as well as received the media is sent. Similar checks are done by all the participants of the chat and the host may change the rules anytime.

When the host changes the settings of the conference while the session is on, the changes are once again communicated to all the participants of the chat with a special signaling message. Based on the changes, the realization of media is achieved. While the host sets the rules, conflicting rules should not be allowed. Alerts should be shown while this is done. The host cannot prevent himself from receiving or sending any kind of media. The host can only mute audio or video while the session is on.

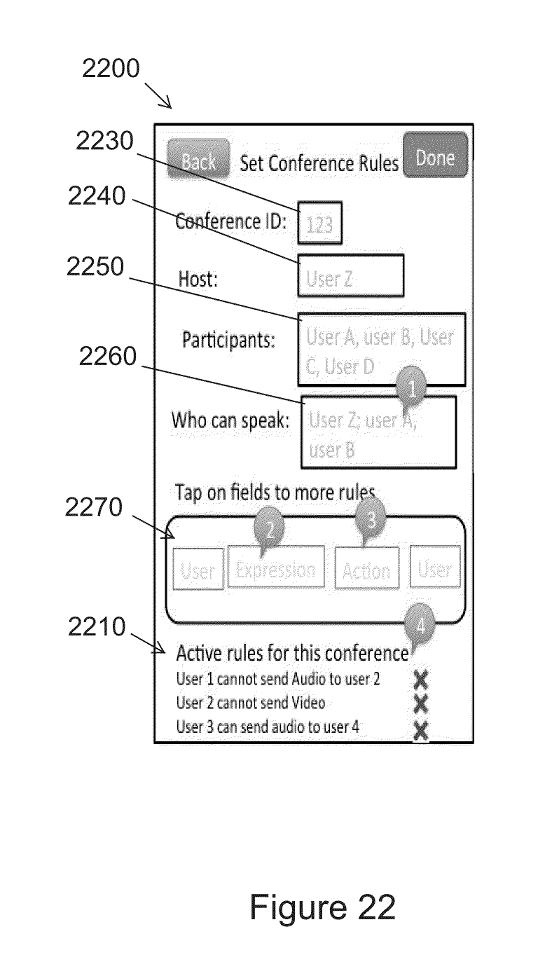

FIG. 22 is a front perspective view of a user interface 2200 for establishing one or more dynamic media rules in a hosted conference, in accordance with one embodiment of the present invention.

Only selected users can speak in the conference. However all users can hear the conference by default. The following rules can be set to override this. Select between can and cannot, actions sent are audio and receive, audio and send video or receive video and select an option to delete any previously entered rule. The active rules for the conference are displayed on the bottom 2210 of the user interface 2200. The user interface 2200 also includes a conference ID number 2230, a host 2240, one or more participants 2250, who can speak 2260 and a plurality of tap on fields to more rules 2270.

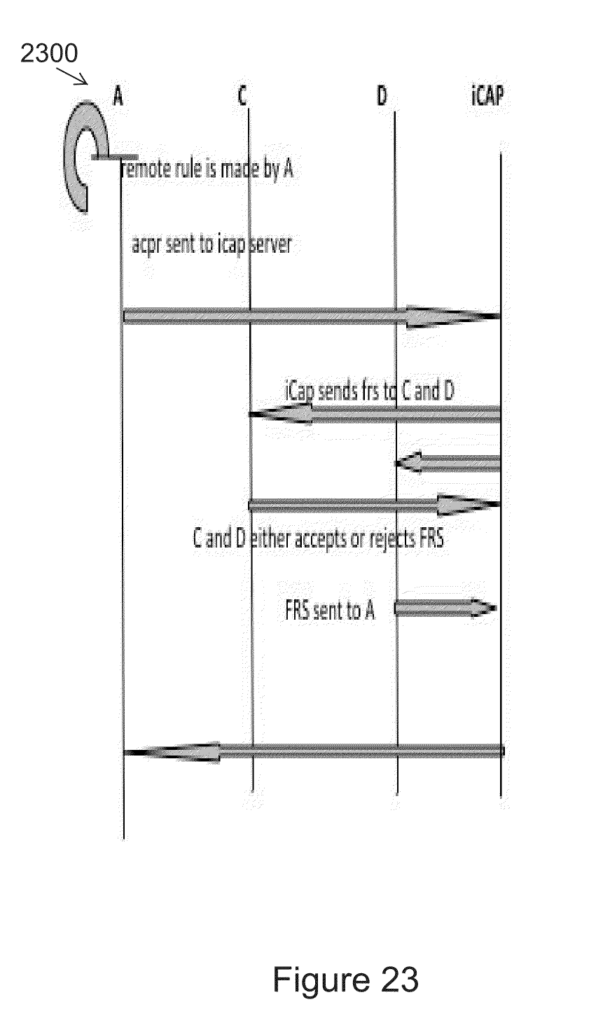

FIG. 23 is a flowchart of a method 2300 for establishing one or more dynamic media rules in a hosted conference in a system to serve as an independent multimedia exchange with one or more self-correcting and collaborative properties being distributed, in accordance with one embodiment of the present invention.

In a preset conference the conference starts at a particular time and defines who can speak and who can listen. It should be also possible that one of the participant's talk and the media can be heard and realized by a set of participants and not by all. A user should be able to preset the media in such a way that only selected users can talk at a time, only selected users can realize the selected media and the system should also allow the media to dynamically change the preset conference. User A wants to have a preset conference with user C and user D at a specific date and time. During the conference user A enforces that user C can only listen but not talk and user D can both listen and talk. User A sends an ACPR to an ICAP server and the IPAC server sends a FRS to user C and user D. In the FRS to user C, it will be mentioned that user C will not be able to talk. In the FRS to user A and user D, it will be mentioned that no stream will be received from user B.

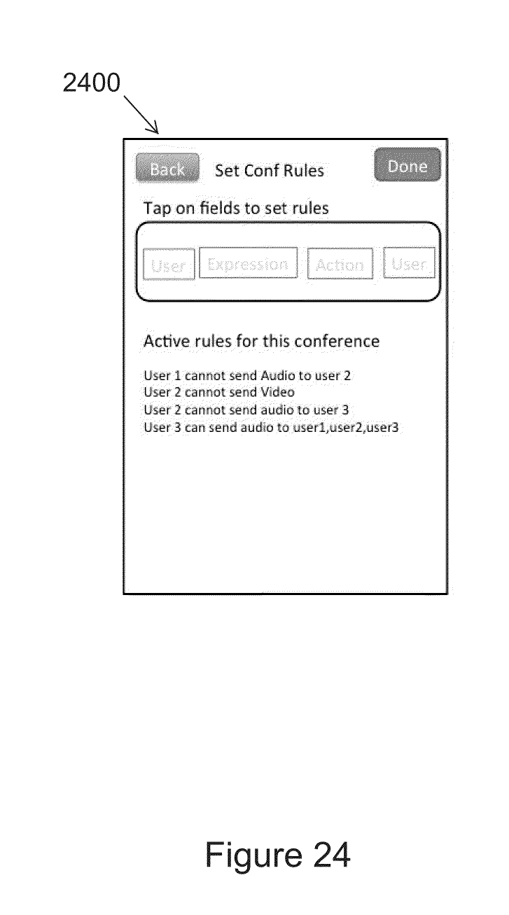

FIG. 24 is a front perspective view of a user interface 2400 for establishing one or more dynamic media rules in a hosted conference, in accordance with one embodiment of the present invention.

The user interface 2400 lists all of the participants on the conference. A user can select only 1 user. A user would then choose between can and cannot. Possible actions include hear audio, send audio, receive audio, send video and send text. The user interface 2400 also lists all active participants other than the participants selected previously. More than one participant can be selected with the user interface 2400.

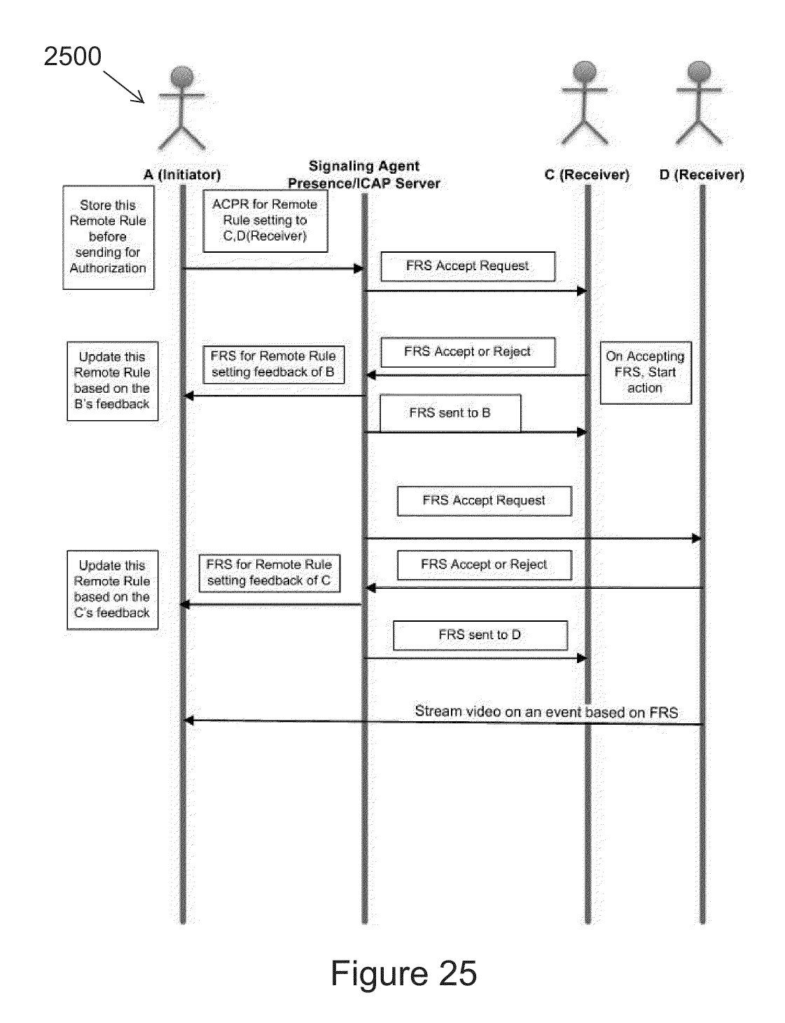

FIG. 25 is a flowchart of a method 2500 for streaming media based on an event in a system to serve as an independent multimedia exchange with one or more self-correcting and collaborative properties being distributed, in accordance with one embodiment of the present invention.

The method 2500 describes that on no event or on a set of events to send GPS coordinates, stream and FTP multiple media from a user interface or from a personal computer or PC or from a server to any user interface in one or more particular events. The user configures in such a way that no event or set of events are GPS coordinates and stream multiple media sent. This is a local rule setting applied by the user.

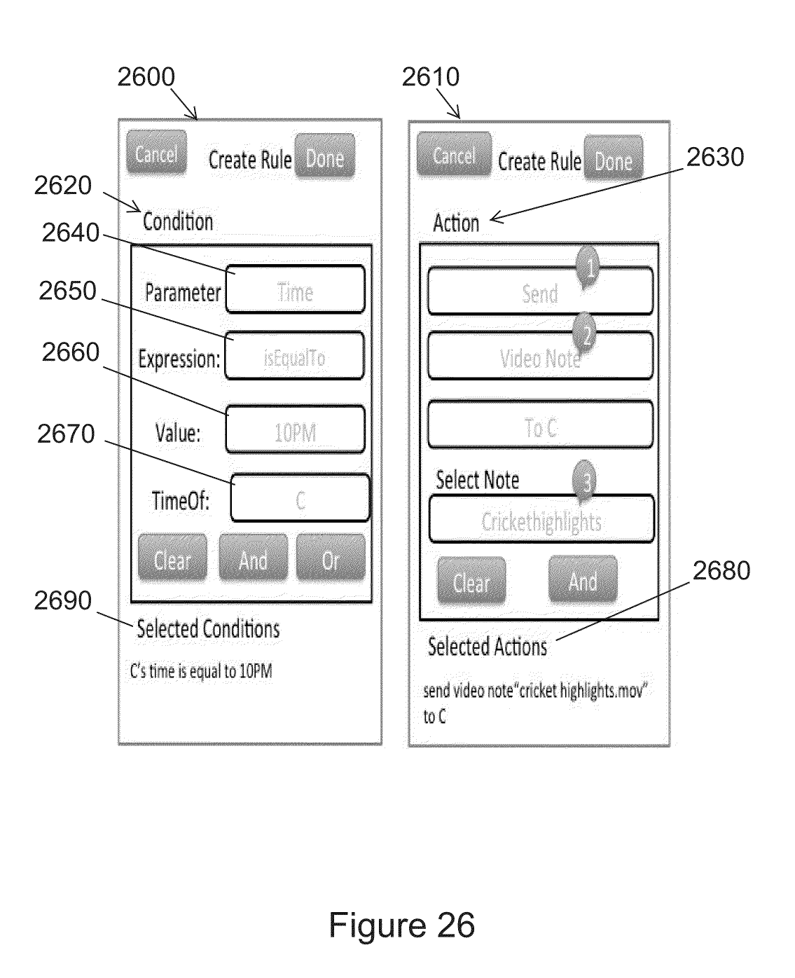

FIG. 26 is a front perspective view of a pair of user interfaces 2600, 2610 with a plurality of selected conditions settings 2620 and a plurality of selected actions settings 2630 in a system to serve as an independent multimedia exchange with one or more self-correcting and collaborative properties being distributed, in accordance with one embodiment of the present invention.

The selected conditions settings 2620 include a parameter setting 2640, an expression setting 2650, a value setting 2660, and a time of setting 2670. The selected actions settings 2630 include a plurality of selected actions 2680 such as initiate service, video page to a user and other suitable action settings. The selected actions 2680 and selected conditions 2690 are displayed on the bottom of the pair of user interfaces 2600.

Alternative options are stream, audio note, text, photo, GPS use, and desktop. If some of the options include a note, an option is provided to select location of the note. A file explorer of interface is also displayed.

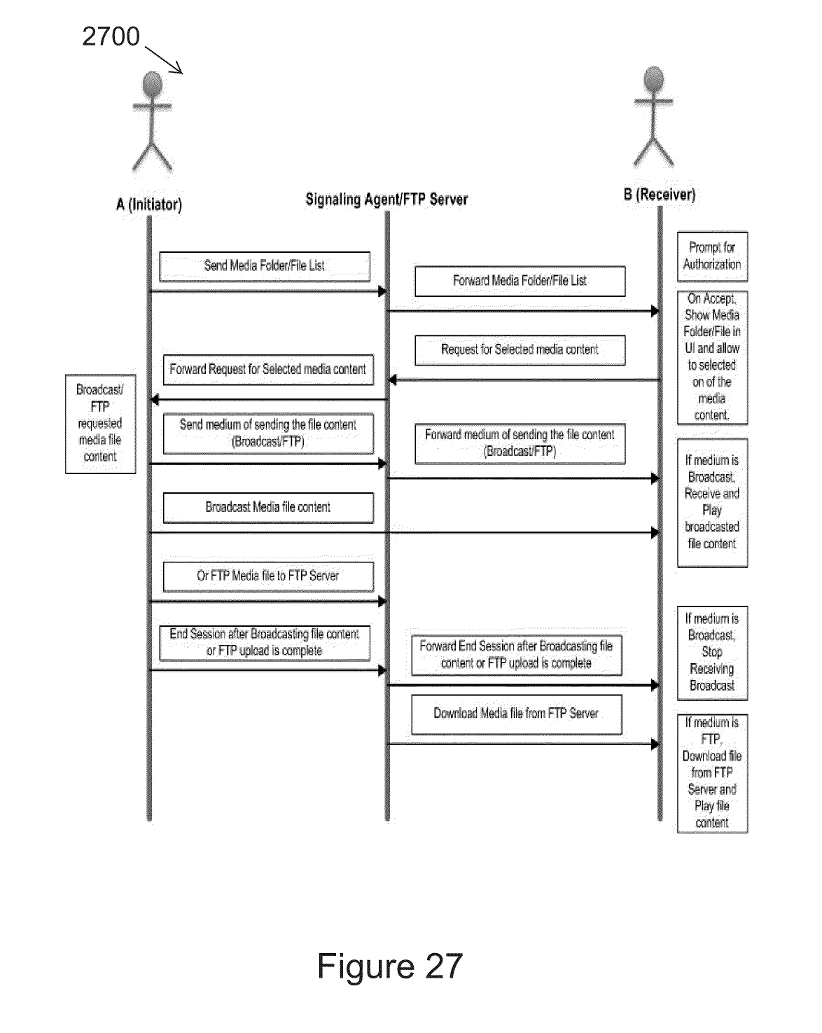

FIG. 27 is a flowchart of a method 2700 for one or more buddies to access a plurality of user files in a system to serve as an independent multimedia exchange with one or more self-correcting and collaborative properties being distributed, in accordance with one embodiment of the present invention.

The user interface multiple media with a plurality of restrictions shows and allows other selected users to choose a chosen media that will be streamed and forwarded by FPT to the requestor. The method 2700 includes one or more buddies to access a plurality of user files to:

send a media folder and file list through signaling message to a receiver;

on acceptance, the folder and file list is shown in the UI and a media file is selected and a request for media content is sent;

send medium of sending the file content, either Broadcast or through FTP;

broadcast media file or upload media file to FTP Server, based on the medium selected;

receive broadcast feed and play based on the medium received;

send end session message after completing broadcast or upload of media file is completed; and

stop receiving broadcast feed and stop playing or download the media file and play it.

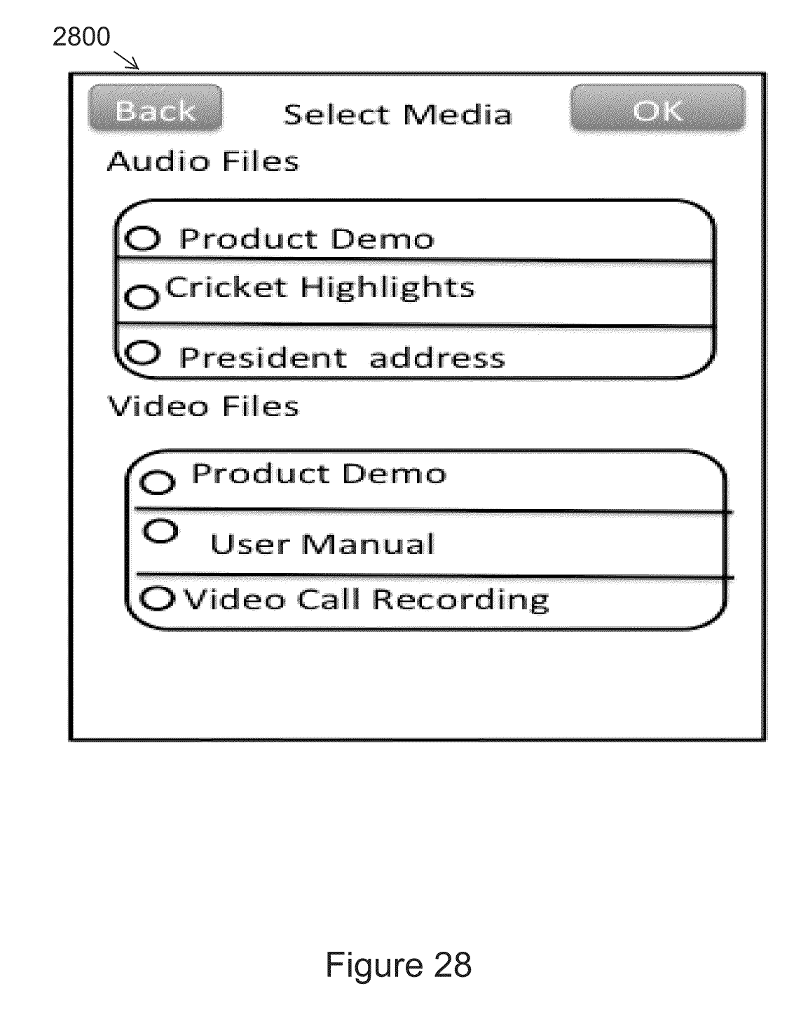

FIG. 28 is a front perspective view of a user interface 2800 for selecting a media that a user would like to view in a system to serve as an independent multimedia exchange with one or more self-correcting and collaborative properties being distributed, in accordance with one embodiment of the present invention.

The user interface 2800 allows the user to select a desired media to view. Once the media is selected, the requested file is sent to a buddy and the file gets played locally. The request file is then locally played like any other suitable media file.

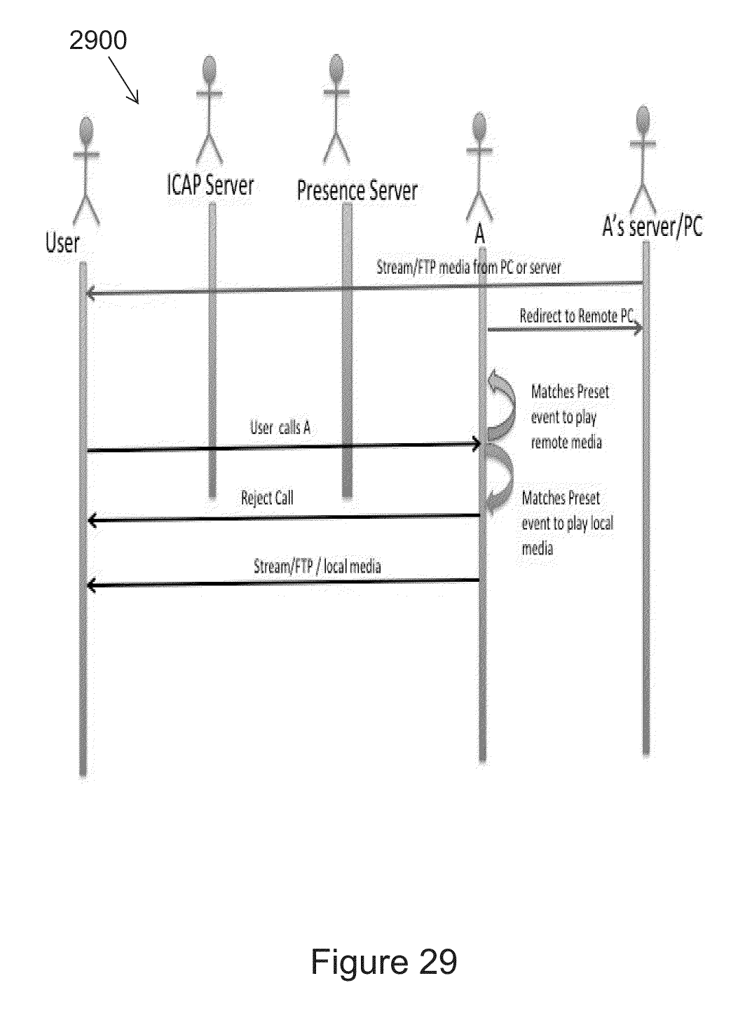

FIG. 29 is a flowchart of a method 2900 for one or more buddies to access a plurality of user files in a system to serve as an independent multimedia exchange with one or more self-correcting and collaborative properties being distributed, in accordance with one embodiment of the present invention.

When a user chats with user A, user A can preset an event where a stream, an FTP and a redirect multiple media from a user interface, a PC or a server to a user interface in one or more particular events. The user can set how many sessions to receive at the same time and how the media should react, based on buddies and a local rule. The user goes to a rules screen and selects the preset events and media to be streamed and transmitted by the FTP.

In the event of an incoming chat, the following conditions are checked:

when conditions are met, reject the incoming chat and stream and send the media to the caller;

if a condition is set to stream media from another device, establish connection with that device; and

stream media from the remote device.

In case the events do not match, continue with the chat and in case connection with the PC or the server is not established, one or more error messages are shown and the call is disconnected.

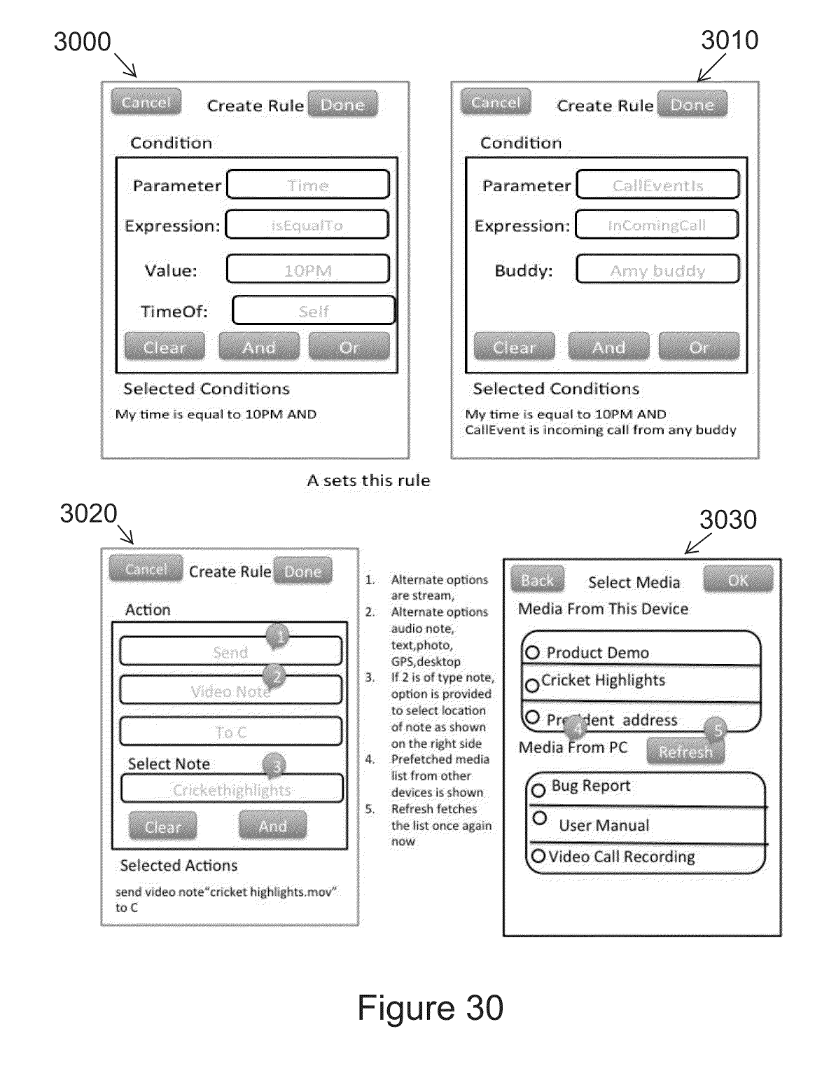

FIG. 30 is a front perspective view of 4 user interfaces 3000, 3010, 3020, 3030 for one or more buddies to access a plurality of user files in a system to serve as an independent multimedia exchange with one or more self-correcting and collaborative properties being distributed, in accordance with one embodiment of the present invention.

Alternate options are stream, audio note, text, photo, GPS and desktop. If some of the options are a type of note, the option is provided to select location of the note as shown on the right side of the user interface. Pre-obtained media list from other devices is provided and the pre-obtained media list can be refreshed as well.

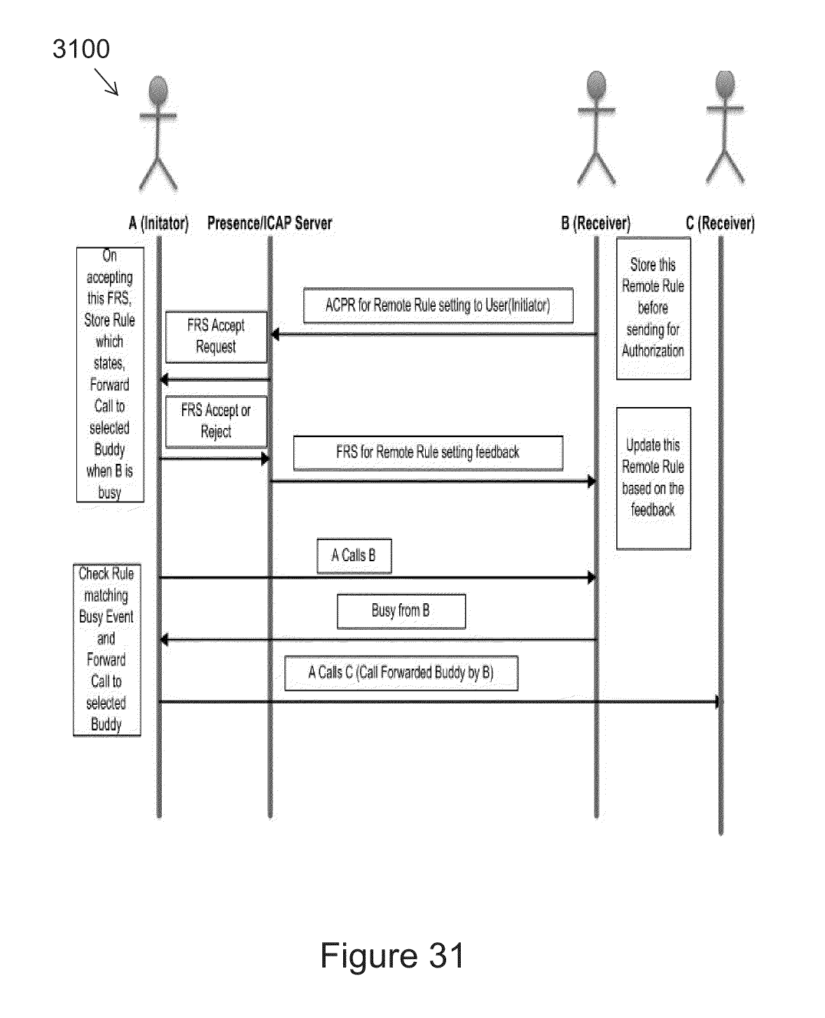

FIG. 31 is a flowchart of a method 3100 for call forwarding an event to a system to serve as an independent multimedia exchange with one or more self-correcting and collaborative properties being distributed, in accordance with one embodiment of the present invention.

In the method 3100, user A calls user B on an event that can forward a chat to a selected buddy. When user A calls user B on an event (B is busy), user B forwards the call to a selected buddy. User B has authorization from the selected buddy to forward the call from user A.

User B sets a remote rule to user A for call forwarding to the selected buddy when user A calls user B and on the event of user B is busy. In the busy event of outgoing call when user A chats with user B, user A checks an FRS table and if the condition is met, automatically initiate a call to the selected call forwarding buddy.

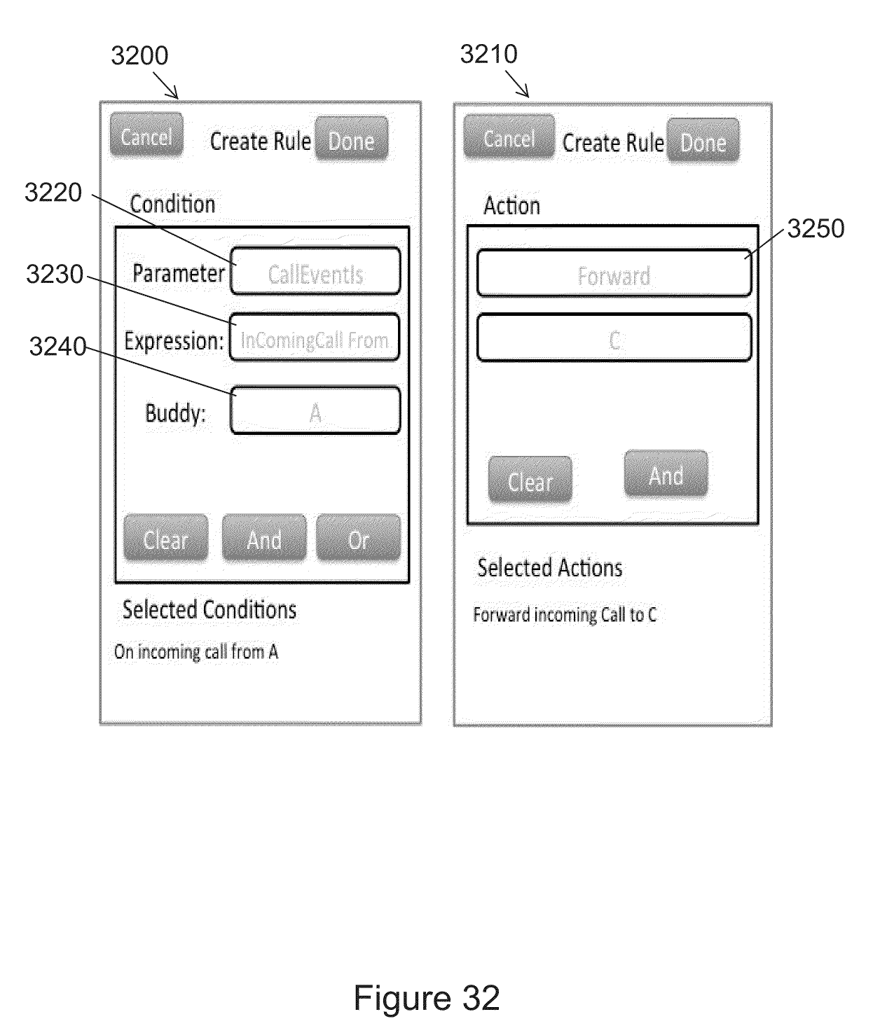

FIG. 32 is a front perspective view of a pair of user interfaces 3200, 3210 to call forward an event in a system to serve as an independent multimedia exchange with one or more self-correcting and collaborative properties being distributed, in accordance with one embodiment of the present invention.

The pair of user interfaces 3200, 3210 includes a parameter 3220, an expression 3230, a buddy 3240 and an action 3250. The selected conditions 3260 and the selected actions 3270 are displayed on the bottom of the pair of user interfaces 3200, 3210.

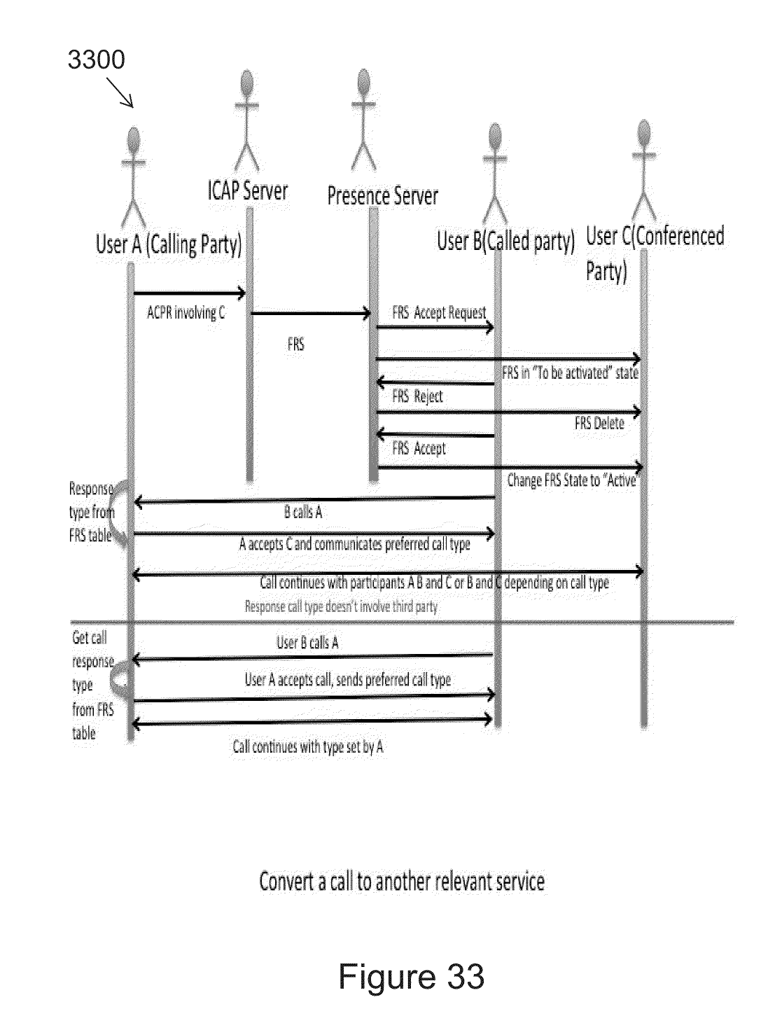

FIG. 33 is a flowchart of a method 3300 for converting a chat to another relevant service for a system to serve as an independent multimedia exchange with one or more self-correcting and collaborative properties being distributed, in accordance with one embodiment of the present invention.

When user A chats with user B regarding an event user B can convert the chat to another relevant service such as a conference, a transfer, a unicast, a hold or give a unicast to user A and take a message from user A and forward to another buddy.

User A sets a rule selecting the service type with which to response for incoming calls from user B. If the service type with which user A would like to respond includes involvement of third parties such as a transfer or a conference, an ACPR is created and a convert service is sent to an ICAP server. The ICAP server generates an FRS and places a FRS approval request for user C to whom the call will be transferred to or forwarded. The FRS for conference or transfer is sent to user B with a “To be Activated” state. On FRS acceptance by user C, the FRS is set to an active state in user B in the next heartbeat response of user B. When user A chats with user B, user C is also automatically conferenced or a call gets transferred to user C. If the service type with which user A would like to respond doesn't include third parties, in the chat accept signaling, user A sends back the service type with which he wishes to respond. Chat type between user A and user B is converted as per the FRS. In case user C denies the FRS, the corresponding FRS is marked for deletion and deleted in user B in the next heartbeat response. Rule involves transfer or conference, to check if user C is a buddy of user B. If not appropriate messages must be shown to user A.

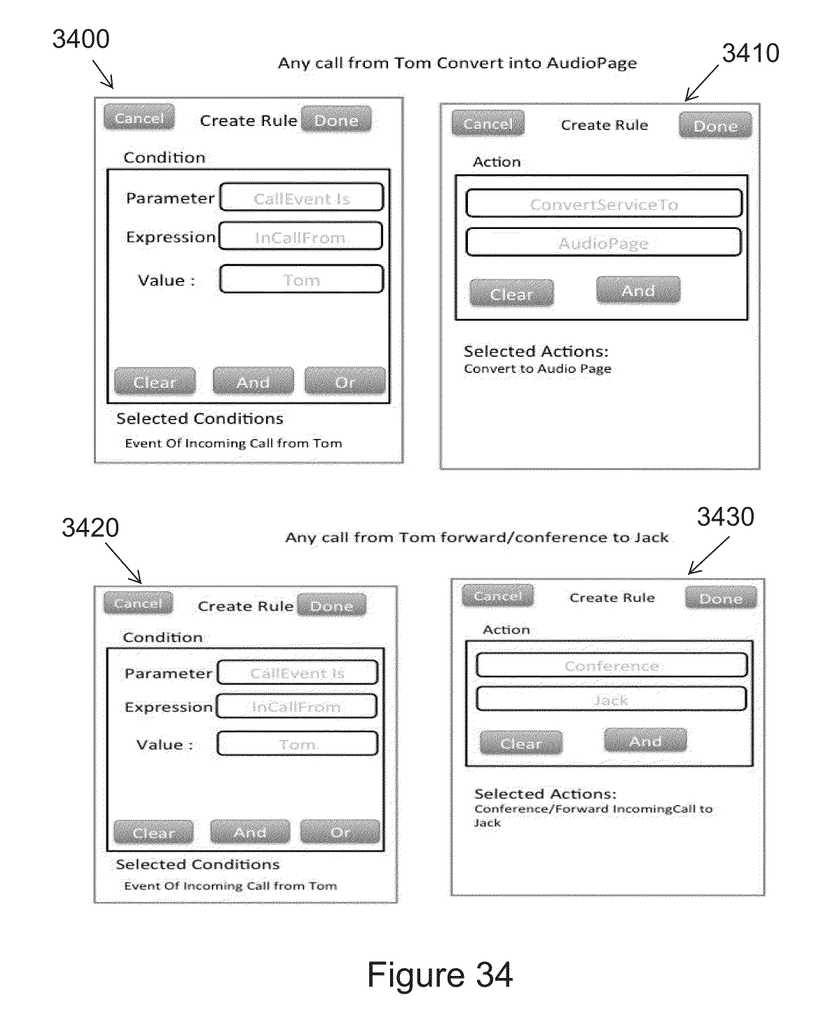

FIG. 34 is a front perspective view of 4 user interfaces 3400, 3410, 3420, 3430 to convert a chat to another relevant service in a system to serve as an independent multimedia exchange with one or more self-correcting and collaborative properties being distributed, in accordance with one embodiment of the present invention.

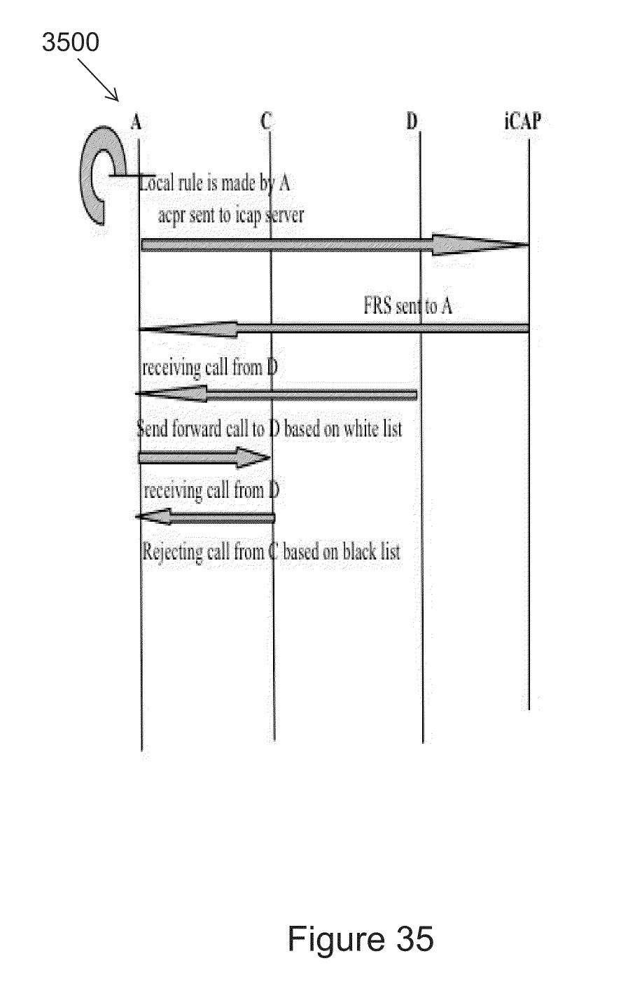

FIG. 35 is a flowchart of a method 3500 for generating a blacklist and a forward list for a system to serve as an independent multimedia exchange with one or more self-correcting and collaborative properties being distributed, in accordance with one embodiment of the present invention.

If user A calls user B, user B can selectively reject or forward based on a black list and a forward list. User can configure their black list and chat forwarding settings. Based on the settings, calls can be rejected or forwarded.

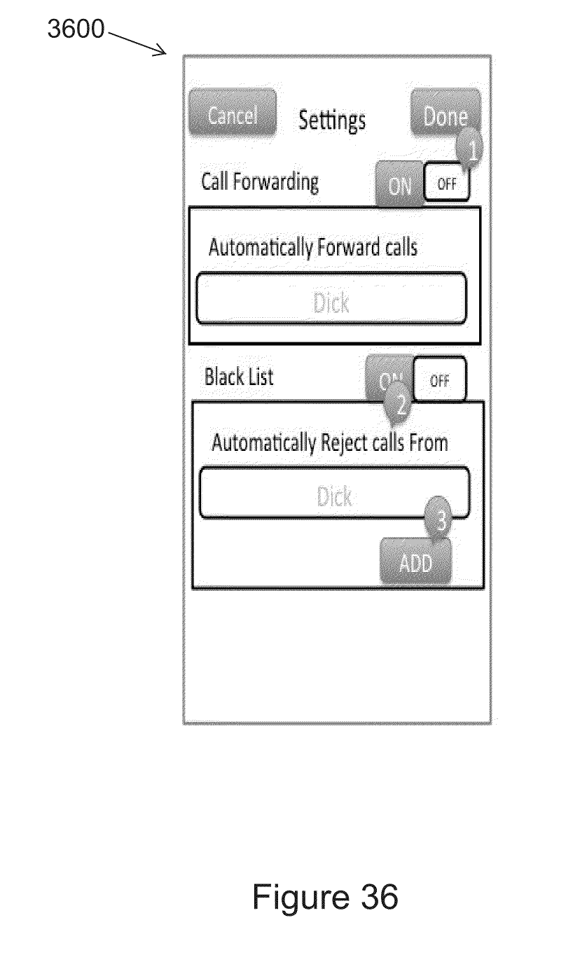

FIG. 36 is a front perspective view of a user interface 3600 for generating a blacklist and a forward list in a system to serve as an independent multimedia exchange with one or more self-correcting and collaborative properties being distributed, in accordance with one embodiment of the present invention.

Turn on and turn off the settings for call forwarding or reject. When turned on, all types of calls will be forwarded. This takes precedence over other rules that may be set. A call from any buddy added to this black list will automatically be rejected. There is also an ability to add more than one person to the black list.

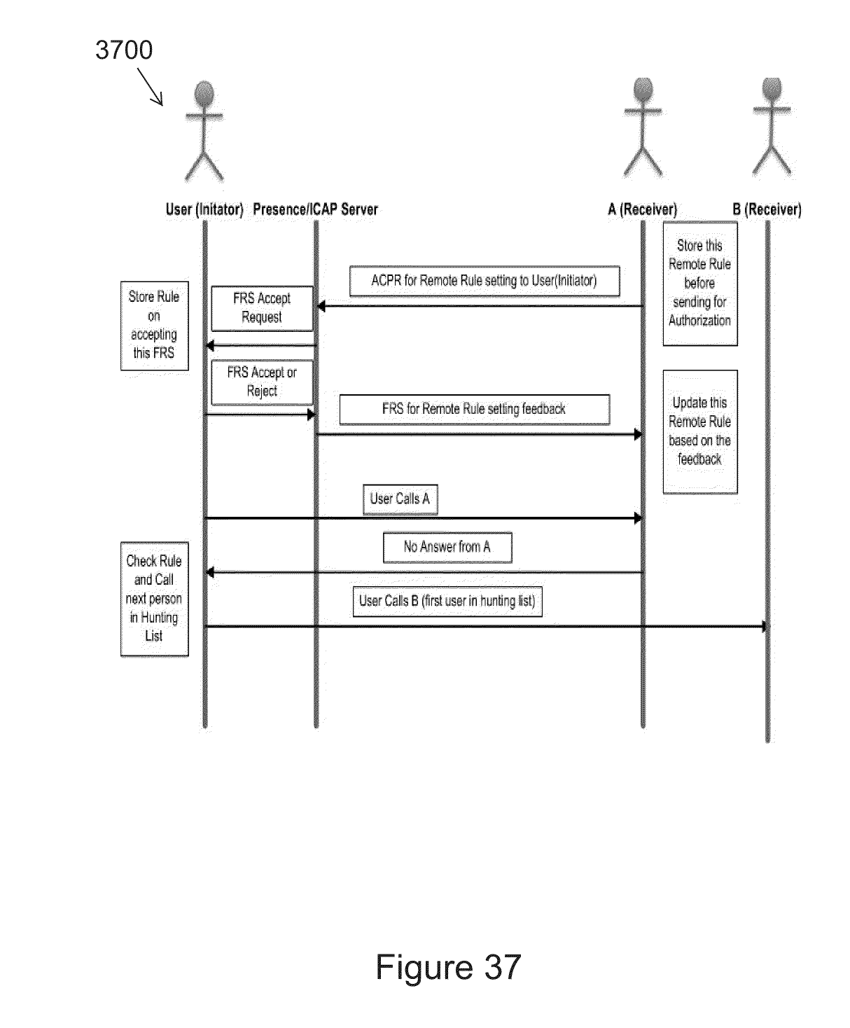

FIG. 37 is a flowchart of a method 3700 for call hunting a system to serve as an independent multimedia exchange with one or more self-correcting and collaborative properties being distributed, in accordance with one embodiment of the present invention.

When a user chats A if A is not available automatically forward the chat to another user in the hunting list as defined by A. User goes to the settings to turn on call hunting. Set the buddies to whom the chat will get hunted in case user is not reachable.

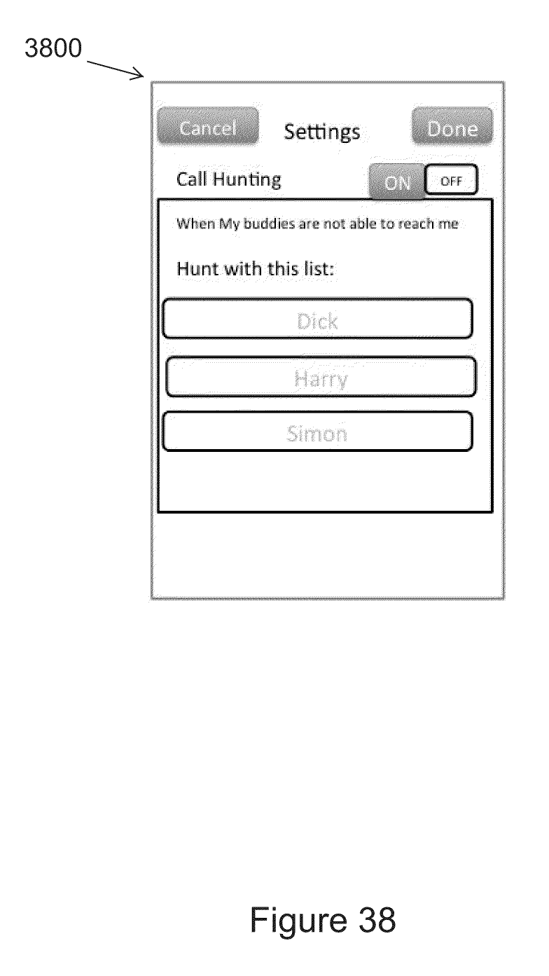

FIG. 38 is a front perspective view of a user interface 3800 for call hunting in a system to serve as an independent multimedia exchange with one or more self-correcting and collaborative properties being distributed, in accordance with one embodiment of the present invention.

A turns on call hunting so that when a user calls A and A is not available, the call is forwarded to his hunting list.

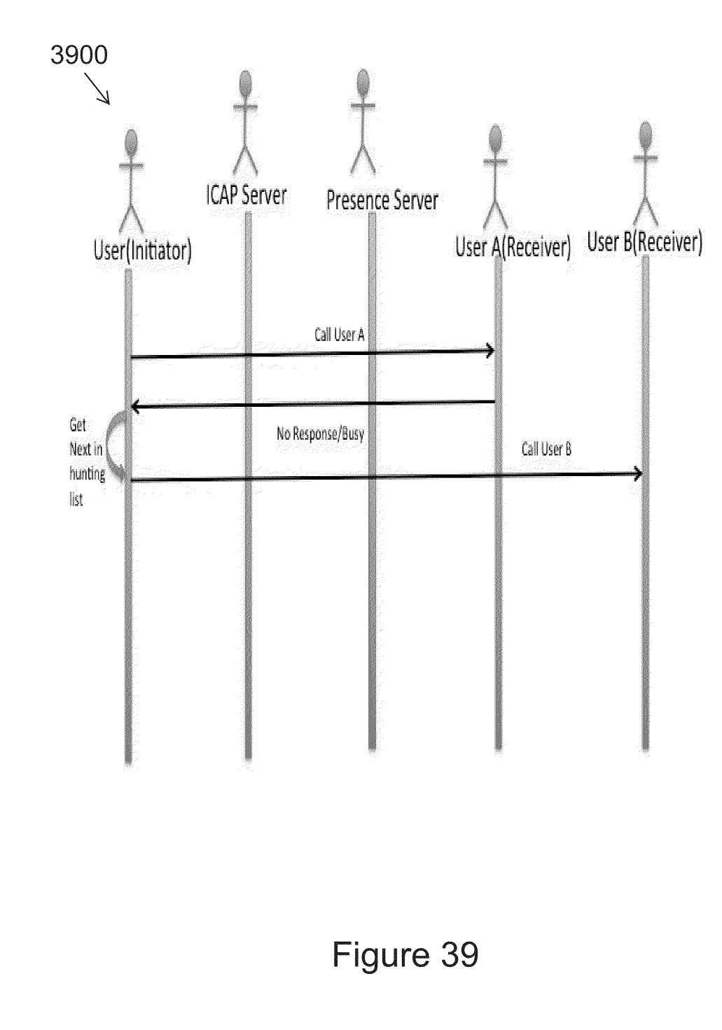

FIG. 39 is a flowchart of a method 3900 for call hunting using a caller's hunting list for a system to serve as an independent multimedia exchange with one or more self-correcting and collaborative properties being distributed, in accordance with one embodiment of the present invention.

When a user chats A and if A is not available, the hunting list is used as defined by the user. User only has a hunting list. A doesn't have a hunting list defined. If A also has defined a hunting list this is covered by yet another use case.

User sets a local rule Begin Chat Hunting From My List. In the No Response Event of any outgoing chats check FRS table and if the condition is met, automatically initiate a chat to the next person in the user's hunting list. If the next person on the user's hunting list is offline or not responding to the chat, automatically chat to the next person on the list. Continue until either a chat is established or the end of the hunting list is reached. When user sets the rule to hunt based on his hunting list, check if the hunting list is set locally or alert the user to set the list first.

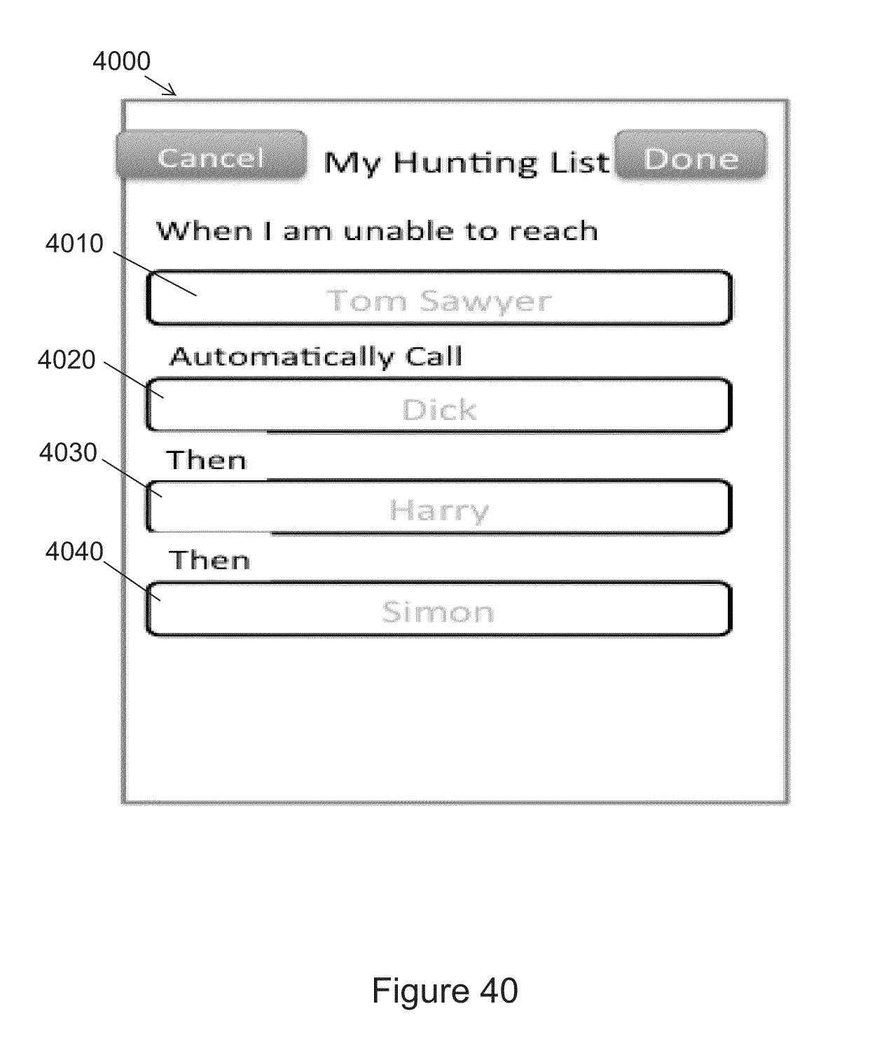

FIG. 40 is a front perspective view of a user interface 4000 for call hunting in a system to serve as an independent multimedia exchange with one or more self-correcting and collaborative properties being distributed, in accordance with one embodiment of the present invention.

The user interface 4000 includes a when I am unable to reach field 4010, an automatically call field 4020, a then call field 1 4030 and a then call field 2 4040.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A system to serve as an independent multimedia exchange with one or more self-correcting and collaborative properties, comprising:
one or more intelligent call processing agents that are a software portion of a mobile device, said one or more intelligent call processing agents that process and control signaling and media processing;
one or more intelligent call processing engines with a plurality of basic features, said one or more intelligent call processing engines are a server system located in a computer cloud and configure said one or more intelligent call processing agents;
one or more filter and routing scripts that are a plurality of XML based instructions, said one or more filter and routing scripts are created and provided by said one or more intelligent call processing engines and are executed and transmitted to said one or more intelligent call processing agents; and
one or more alternative call processing scripts produced by a graphical user interface based call processing editing program, said one or more alternative call processing scripts are processed by said one or more intelligent call processing engines.

2. The system according to claim 1, wherein said one or more intelligent call processing engines have GPS, audio speaker, video accelerator, camera, accelerometer and timer capability.

3. The system according to claim 1, wherein said one or more intelligent call processing engines is a virtual machine which read said one or more filter and routing scripts.

4. The system according to claim 1, wherein said one or more self-correcting and collaborative properties include signing in and logging out.

5. The system according to claim 1, wherein said one or more self-correcting and collaborative properties include managing a plurality of contacts.

6. The system according to claim 1, wherein said one or more self-correcting and collaborative properties include a heartbeat request.

7. The system according to claim 1, wherein said one or more self-correcting and collaborative properties include initiating a communication service with one or more buddies without a relay server.

8. The system according to claim 7, wherein said one or more self-correcting and collaborative properties include initiating said communication service with said one or more buddies with said relay server.

9. The system according to claim 7, wherein said one or more self-correcting and collaborative properties include communicating with said one or more buddies based on one or more rules.

10. The system according to claim 9, wherein said one or more self-correcting and collaborative properties include enforcing said one or more rules on said one or more buddies.

11. The system according to claim 7, wherein said one or more self-correcting and collaborative properties include said one or more buddies accessing a plurality of said user files.

12. The system according to claim 1, wherein said one or more self-correcting and collaborative properties include performing recording media and playing said recording media later.

13. The system according to claim 1, wherein said one or more self-correcting and collaborative properties include establishing one or more dynamic media rules in a hosted conference.

14. The system according to claim 1, wherein said one or more self-correcting and collaborative properties include streaming media based on an event.

15. The system according to claim 14, wherein said one or more self-correcting and collaborative properties include call forwarding said event.

16. The system according to claim 1, wherein said one or more self-correcting and collaborative properties include selecting a media said user would like to view.

17. The system according to claim 1, wherein said one or more self-correcting and collaborative properties include converting a chat into a selected one of a conference, a transfer and a unicast.

18. The system according to claim 1, wherein said one or more self-correcting and collaborative properties include generating a blacklist.

19. The system according to claim 1, wherein said one or more self-correcting and collaborative properties include generating a forward list.

20. The system according to claim 1, wherein said one or more self-correcting and collaborative properties include call hunting.
